(19) United States
(12) Patent Application Publication
(10) Pub. No.: US 2007/0230423 A1
(43) Pub. Date: Oct. 4, 2007

(54) WIRELESS COMMUNICATION SYSTEM

(75) Inventors: Takeshi YOSHIDA, Osaka (JP); Taro MIKAMI, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/690,457

(22) Filed: Mar. 23, 2007

(30) Foreign Application Priority Data
Mar. 28, 2006 (JP) 2006-087747
Mar. 16, 2007 (JP) 2007-69404

(51) Int. Cl. H04Q 7/24

(52) U.S. Cl. 370/338

(57) ABSTRACT

A wireless communication system, a wireless terminal and a wireless communication method which can realize a high throughput even when communication is performed between plural terminal pairs are provided. A wireless communication system according to the present invention includes a wireless LAN base station and plural terminals which mutually communicate through the wireless LAN base station, each of the terminals includes a communication unit operable to perform inter-terminal direct communication with an other terminal, using a second wireless channel that is different from a first wireless channel, the first wireless channel being used in wireless communication with the base station, the inter-terminal direct communication being communication that bypasses the wireless LAN base station.

### BACKGROUND OF THE INVENTION

(1) Field of the Invention

The present invention relates to a wireless communication system, and particularly to a wireless communication system which bypasses a base station and performs communication between terminals using a wireless LAN.

(2) Description of the Related Art

In the conventional communication method between different terminals in wireless LAN systems proposed in the conventional IEEE802.11, when two different terminals (stations) mutually communicate, communication is performed via relays through access points which serve as base stations (see for example Non-patent Document 1, “International Standard ISO/IEC 8802-11: 1999(E)ANSI/IEEE Std 802.11, 1999 Edition” IEEE802.11 Standard Specification).

FIG. 1 is a diagram which shows the structure of a conventional wireless LAN system and a flow for data transmission. The wireless communication system shown in FIG. 1 includes an access point 3401, a terminal 3402 and a terminal 3403, which mutually perform wireless communication via the access point 3401.

When transmitting data from terminal 3402 to terminal 3403, terminal 3402 designates the address of terminal 3403 as the destination address and transmits data to be transmitted to terminal 3403 to the access point 3401 (S3404). The access point 3401 can ascertain that the received data is data relayed to terminal 3403 from header information attached to the front of the data. When the access point 3401 has acknowledged that the received data is data relayed to terminal 3403, the data transmitted from terminal 3402 is transmitted to terminal 3403 (S3405).

FIG. 2 is a diagram which shows the communication time when data is transmitted from terminal 3402 to terminal 3403 in the wireless communication system shown in FIG. 1. As shown in FIG. 2, the communication time T1 necessary for one communication from terminal 3402 to terminal 3403 is the total time of the communication time necessary for a communication 3501 from terminal 3402 to the access point 3401 and the communication time necessary for a communication 3502 from the access point 3401 to terminal 3403. In this way, since data communication in a conventional wireless communication system performs communication via the access point 3401, communication time from the transmission side terminal 3402 to the access point 3401, and communication time from the access point 3401 to the receiving side terminal 3403 become necessary and a satisfactory throughput cannot be obtained.

In contrast, inter-terminal direct communication which extends the IEEE802.11 specifications, bypasses the access points and communicates directly between terminals has been considered (see Non-Patent Reference 2, “IEEE Standard for Information Technology—Telecommunications and Information Exchange Between Systems—LAN/MAN Specific Requirements—Part 11 Wireless Medium Access Control (MAC) and Physical Layer (PHY) specifications: Medium Access Control (MAC) Quality of Service (QoS) Enhancements” IEEE802.11e Standard Specification).

FIG. 3 is a diagram which shows the structure of a wireless LAN system and a data transmission flow for performing conventional inter-terminal direct communication. When a terminal 3602 in FIG. 3 performs direct data communication with a terminal 3603 and bypasses an access point 3601, terminal 3602 must perform a procedure beforehand with the access point 3601 in order to perform inter-terminal direct communication with terminal 3603. Also, terminal 3602, terminal 3603 and the access point 3601 must all support inter-terminal direct communication.

When data is transmitted from terminal 3602 to terminal 3603, terminal 3602 requests that the access point 3601 perform inter-terminal direct communication with terminal 3603 (S3604). The access point 3601 which has accepted the request judges whether or not terminal 3603 is a terminal which supports inter-terminal direct communication. Here, when the access point 3601 has established a wireless link between terminal 3603 and the access point 3601, the access point 3601 can acquire information about whether or not terminal 3603 is a terminal which supports inter-terminal direct communication. When terminal 3603 supports direct communication, the access point 3601 transmits a permission notification for inter-terminal direct communication to terminal 3602 (S3605).

Terminal 3602, which has received the permission notification, performs inter-terminal direct communication with terminal 3603 (S3606).

FIG. 4 is a diagram which shows the amount of communication time when data is transmitted from terminal 3602 to terminal 3603 in inter-terminal direct communication. In inter-terminal direct communication as shown in FIG. 4, a communication time T2 when transmitting data from terminal 3602 to terminal 3603 consists of only a communication time 3701 from terminal 3602 to terminal 3603. When compared with the case in which data transmission is performed via the access point as shown in FIG. 2, data can be communicated in half the time using inter-terminal direct communication. Thus, the throughput can be improved by using inter-terminal direct communication, more so than a method of communicating via an access point.

### SUMMARY OF THE INVENTION

Below, some problems of wireless LAN systems which utilize conventional inter-terminal direct communication are shown.

FIG. 5 is a diagram which shows the structure of a wireless LAN system and a data flow when inter-terminal direct communication is performed between terminals, and data communication is performed simultaneously between a terminal that performs inter-terminal direct communication, another terminal and an access point. The wireless LAN system in FIG. 5 includes an access point 3801, a terminal 3802 and a terminal 3803 which perform inter-terminal direct communication and a terminal 3804 which performs data communication with the access point 3801.

The access point 3801 establishes a wireless link on which can communicate between terminal 3802, terminal 3803 and terminal 3804. Also, terminal 3802 finishes a procedure for performing inter-terminal direct communication with terminal 3803 for the access point 3801.

FIG. 6 is a diagram which shows the amount of communication time when communication is performed in the wireless LAN system shown in FIG. 5. Since wireless communication between the access point 3801 and terminal 3804, and inter-terminal direct communication between terminal 3802 and terminal 3803 are performed through the same station (on the same wireless channel), the two communications cannot be performed simultaneously. Thus, while the access point 3801 performs a communication 3901 with terminal 3804 as shown in FIG. 6, inter-terminal direct communication cannot be performed between terminal 3802 and terminal 3803 and an inter-terminal direct communication 3902 is performed between terminal 3802 and terminal 3803, after the communication 3901 is finished between the access point 3801 and terminal 3804.

In wireless communication according to IEEE802.11, half-duplex mode communication is performed. Therefore, communication between two different terminal pairs in the same time period cannot be performed simultaneously. Thus, while a terminal pair communicates, a different pair cannot communicate and the different pair must wait until the terminal pair has finished communication before communicating.

Compared to when only inter-terminal direct communication is performed between terminal 3802 and terminal 3803, the time in which wireless communication can be performed decreases when communication between the access point 3801 and terminal 3804 and inter-terminal direct communication between terminal 3802 and terminal 3803 is performed. Thus, the throughput in inter-terminal direct communication drops.

It follows from the above that in a wireless communication system such as a conventional wireless LAN system, there is the problem that the throughput drops when plural communications are performed between terminals. Note that here, “inter-terminal” includes communication between a terminal and a terminal, as well as communication between a terminal and an access point.

The present invention is realized in consideration of the problems above and takes as an object providing a wireless communication system, a wireless terminal and a wireless communication method which can realize a high throughput even when communications are performed between plural terminals.

In order to accomplish the objects above, the wireless communication system according to the present invention includes a wireless communication system that includes a wireless LAN base station; and plural terminals which mutually communicate through the wireless LAN base station, each of the terminals includes a communication unit which performs inter-terminal direct communication with an other terminal, using a second wireless channel that is different from a first wireless channel, the first wireless channel being used in wireless communication with the base station, inter-terminal direct communication being communication that bypasses the wireless LAN base station.

With this structure, plural terminals perform inter-terminal direct communication with another terminal, inter-terminal direct communication being communication which bypasses the base station and uses the second wireless channel which differs from the first wireless channel that is used in wireless communication with the base station. Thus, even when inter-terminal direct communication and communication between the base station and the other terminal are performed simultaneously, since the wireless channels used differ, the data transmission in inter-terminal direct communication and the data transmission between the base station and the other terminal can be performed in parallel. In other words, even when inter-terminal direct communication and communication between the base station and the other terminal are performed simultaneously, the throughput will not drop. Thus, even when communications are performed among plural terminals in the wireless communication system in the present invention, a high throughput can be realized.

Also, each communication unit includes a request transmission unit which transmits a request signal which is a signal that requests the wireless LAN base station to perform inter-terminal direct communication; the wireless LAN base station includes a permission unit which permits the terminal which transmits the request signal and a terminal which is a communication peer for the terminal which transmits the request signal to perform inter-terminal direct communication; and the communication unit may perform inter-terminal direct communication with the terminal which is a communication peer when permitted by the permission unit.

With this configuration, the terminal which performs inter-terminal direct communication transmits the request signal for performing inter-terminal direct communication to the base station. Thus, the base station can ascertain the terminals which perform inter-terminal direct communication and the wireless channel used in inter-terminal direct communication. Thus, the base station can easily control the wireless link.

Also, the request transmission unit may request to the wireless LAN base station that inter-terminal direct communication be performed using an information element of a Direct Link Setup request.

With this configuration, the terminal which performs inter-terminal direct communication can transmit a request to the base station to perform inter-terminal direct communication using an information element of the DLS-Request used in conventional wireless LAN communication. Thus, inter-terminal direct communication can be performed on a wireless channel different from the wireless channel that the base station uses in communication without greatly modifying the conventional wireless LAN communication system.

Also, the request transmission unit may request the wireless LAN base station to perform inter-terminal direct transmission using an information element of an association-request.

With this structure, the terminal which performs inter-terminal direct communication can transmit a request for performing inter-terminal direct communication to the base station using an information element of the association request used in conventional wireless LAN communication. Thus, inter-terminal direct communication can be performed on a different wireless channel from the wireless channel that the base station uses in communication without greatly modifying the conventional wireless LAN communication system. Also, the request to perform inter-terminal direct communication can be transmitted simultaneously with the authentication process (Association process) which is performed when the terminal connects to the wireless link.

Also, the wireless LAN base station may include: a notification signal generation unit which generates a notification signal which includes first channel information which is information about a wireless channel that is compatible with each of the plural terminals; and a notification signal transmission unit which periodically transmits the notification signal generated by the notification signal generation unit, the communication unit includes a notification signal reception unit which receives the notification signal, and each of the terminals includes a channel selection unit which selects the second wireless channel from among wireless channels compatible with the terminal which is a communication peer which are included in the notification signal received by the notification signal reception unit.

With this structure, the terminal which performs inter-terminal direct communication can select the wireless channel used in inter-terminal direct communication using information about wireless channels compatible with the terminal which is a communication peer which is included in the notification signal.

Also, each of the terminals includes a channel information holding unit which holds second channel information which is information about a wireless channel with which the terminal itself is compatible, the communication unit includes a channel information transmission unit which transmits the second channel information held by the channel information holding unit to the wireless LAN base station, and the notification signal generation unit may generate the first channel information based on the second channel information transmitted from the channel information transmission unit in each of the terminals.

With this structure, the base station can acquire wireless channel information compatible with the terminal which has established the wireless link with the base station. Thus, the base station can select the wireless channel used in inter-terminal direct communication from among the wireless channels compatible with the terminal which performs inter-terminal direct communication. Also, using the notification signal, the base station transmits information to each terminal about the wireless channels compatible with the terminal that has established the wireless link. Thus, each terminal can select a wireless channel used in inter-terminal direct communication by acquiring information about the wireless channels compatible with the terminal which is a communication peer.

Also, each of the terminals include a channel information holding unit which holds second channel information which is information about a wireless channel with which the terminal itself is compatible, the communication unit includes a channel information transmission unit which transmits the second channel information held by the channel information holding unit to the wireless LAN base station, and the notification signal generation unit may generate the first channel information based on the second channel information transmitted from the channel information transmission unit in each of the terminals.

With this structure, the base station can select the wireless channel used in inter-terminal direct communication. Thus, the structure of the terminals can be simplified since the terminal does not need to be functional to select the wireless channel used in inter-terminal direct communication.

Also, the wireless LAN base station may include: a notification signal generation unit which generates a notification signal which includes information about the second wireless channel selected by the channel selection unit; and a notification signal transmission unit which transmits the notification signal generated by the notification signal generation unit to the terminal.

With this structure, the base station can notify the terminal of information about the wireless channels used by the terminal in inter-terminal direct communication.

Also, the channel selection unit may select a wireless channel distanced at least two channels from the first wireless channel.

With this structure, since the base station does not use a wireless channel in inter-terminal direct communication which is proximal to the wireless channel used by the base station, interference in the wireless channel that is proximal to the wireless channel used in inter-terminal direct communication can be reduced.

Also, the channel selection unit includes a use judgment unit which judges whether or not a wireless channel is in use based on whether or not the notification signal is received in each wireless channel available for wireless communication, and the channel selection unit may select the wireless channel used in inter-terminal direct communication from the wireless channels judged by the use judgment unit to be available.

With this structure, the base station or the terminal which selects the wireless channel used in inter-terminal direct communication can select the wireless channel used in inter-terminal direct communication using a wireless channel not used by another base station and the like.

Also, the channel selection unit includes a measurement unit which measures a traffic density of each wireless channel available for wireless communication, and the channel selection unit may select the wireless channel to be used from among the wireless channels with traffic density less than a predetermined value based on the measurement result by the measurement unit.

With this structure, the base station or the terminal which selects the wireless channel used in inter-terminal direct communication can select the wireless channel used in inter-terminal direct communication from among the wireless channels with traffic density less than a predetermined value.

Also, the wireless LAN base station may include a notification signal transmission unit which periodically transmits a notification signal, and each of the plural terminals includes: a notification signal reception unit which receives the notification signal; a counting unit which counts an amount of notification signals received by the notification reception unit; and a channel switching unit which switches the wireless channel to be used in wireless communication from the first wireless channel to the second wireless channel in the case where a count value of the counting unit reaches a predetermined amount.

With this structure, the wireless channel switching timing for the terminal which performs inter-terminal direct communication can be synchronized between terminals. Also, by counting the predetermined amount of notification signals, even when the notification signal cannot be received due to the communication conditions and so on, wireless channel switching can be performed by receiving the next notification signal.

Also, the communication unit includes: a synchronization signal transmission unit which transmits a synchronization signal to the terminal, which is a communication peer, using the first wireless channel; a synchronization signal response unit which responds to the terminal which is a communication peer using the first wireless channel, with information that indicates whether or not the terminal itself is in a state in which channel switching can be performed, when the synchronization signal is received from the terminal which is a communication peer; a channel switching unit which switches the wireless channel used in wireless communication from the first wireless channel to the second wireless channel, in the case where the synchronization signal response unit has responded to the synchronization signal transmitted from the synchronization signal transmission unit in the terminal which is a communication peer, that the channels can be switched, and further, the channel switching unit may switch the wireless channel used in wireless communication from the first wireless channel to the second wireless channel, in the case where the synchronization signal transmission unit transmits the synchronization signal to the terminal which is a communication peer and there is a response from the terminal which is a communication peer which indicates that the terminal which is a communication peer is in a state where the channels can be switched.

With this structure, the wireless channel switching timing for the terminal which performs inter-terminal direct communication can be synchronized between terminals.

Also, the wireless LAN base station may include a transmission prohibited signal generation unit which generates a transmission prohibited signal which is a signal to which information has been added and which indicates that data from the terminal which performs wireless communication on the first wireless channel is prohibited from being transmitted; a transmission prohibition signal transmission unit which transmits the transmission prohibited signal on the first wireless channel to the terminal which performs wireless communication on the first wireless channel; and a channel switching unit which switches the wireless channel used in wireless communication from the first wireless channel to the second wireless channel after the transmission prohibited signal transmission unit transmits the transmission prohibited signal to the terminal which performs wireless communication on the first wireless channel.

With this structure, communication from the other terminal to the base station can be prohibited when the base station changes channels to the wireless channel utilized in inter-terminal direct communication. Thus, when the base station changes channels to the other wireless channel, the other terminal can be prevented from transmitting data to the base station by mistake and losing data.

Also, the wireless LAN base station may include a QoS-CF-Poll signal transmission unit which transmits a QoS-CF-Poll signal using the second wireless channel switched to by the channel switching unit, the QoS-CF-Poll signal being a signal that permits inter-terminal direct communication to start.

With this structure, the base station can transmit the QoS-CF Poll used in a conventional wireless LAN system to the terminal which starts inter-terminal direct communication on a wireless channel different from the wireless channel used by the base station. Thus, inter-terminal direct communication can be performed on the wireless channel which differs from the wireless channel used by the base station without major modification to the conventional wireless LAN system.

Also, the base station may include a channel switching unit which switches the wireless channel used in wireless communication periodically from the first wireless channel to the second wireless channel; and a notification signal transmission unit which transmits a notification signal periodically to the second wireless channel.

With this structure, the base station can transmit the notification signal to the terminal which performs inter-terminal direct communication on the wireless channel that differs from the wireless channel used by the base station. Thus, the terminal receives the notification signal and can synchronize with the base station even when inter-terminal direct communication is performed using a wireless channel which differs from the wireless channel used by the base station.

Also, the base station may include a notification signal transmission unit which periodically transmits a notification signal to the first wireless channel; the communication unit includes a channel switching unit which switches the wireless channel used in wireless communication periodically from the second wireless channel to the first wireless channel; and a notification signal reception unit which receives the notification signal transmitted on the first wireless channel.

With this structure, the terminal can receive the notification signal by switching the the wireless channel used by the terminal to the wireless channel used by the base station by the timing on which the base station transmits the notification signal. Thus, the terminal can synchronize with the base station even when inter-terminal direct communication is performed using a wireless channel that differs from the wireless channel used by the base station. Also, the processes of the base station can be simplified compared to when the base station switches the wireless channel and transmits the notification signal.

Also, the wireless LAN base station may include a data transmission unit which transmits data to one of the terminals using the first wireless channel, the notification signal transmission unit which transmits the notification signal including timing information, which is information about a timing for transmitting data using the data transmission unit, the channel switching unit in the terminal which performs inter-terminal direct communication which switches the wireless channel used in wireless communication from the second wireless channel to the first wireless channel on the timing based on the timing information included in the notification signal, and the communication unit includes a data reception unit which receives data from the wireless LAN base station on the first wireless channel.

With this structure, the terminal which performs inter-terminal direct communication using a wireless channel different from the wireless channel used by the base station can ascertain the timing by which data is transmitted from the base station using the timing information included in the notification signal. Thus, the terminal can easily receive data from the base station by switching the wireless channel according to the timing by which the base station performs data transmission.

Also, the communication unit includes a data transmission unit which transmits data to the wireless LAN base station; and a channel switching unit which switches the wireless channel used in communication from the second wireless channel to the first wireless channel before the data transmission unit starts transmitting data.

With this structure, the terminal which performs inter-terminal direct communication using a wireless channel different from the wireless channel used by the base station can switch the wireless channel used by the terminal to the wireless channel used by the base station, and transmit data to the base station.

Also, the communication unit includes an alert signal transmission unit which transmits an alert signal which is a signal for notifying the wireless LAN base station that communication is to be performed, and the alert signal transmission unit in the terminal which performs inter-terminal direct communication may transmit the alert signal to the wireless LAN base station after the wireless channel used in communication is switched from the second wireless channel to the first wireless channel by the channel switching unit, and the data transmission unit which transmits the data after the notification signal transmission unit transmits the alert signal.

With this structure, the base station can acknowledge that data is transmitted from the terminal which performs inter-terminal direct communication via an alert signal such as a PS-Poll signal.

Also, each of the terminals include a data judgment unit which judges whether or not there is data to be transmitted to the wireless LAN base station, and the data transmission unit may finish data transmission to the wireless LAN base station when the data judgment unit judges that there is no data to be transmitted to the wireless LAN base station during the data transmission to the wireless LAN base station.

With this structure, the terminal finishes transmitting data to the base station after all the data to be transmitted to the base station has been transmitted. Thus, data can be efficiently transmitted since the time necessary to actually transmit data can be allocated to data transmission from the terminal to the base station.

Also, each of the terminals includes a time judgment unit which judges whether or not a predetermined time elapses, and the data transmission unit may finish data transmission to the wireless LAN base station when the time judgment unit judges that the predetermined time period elapses during the data transmission to the wireless LAN base station.

With this structure, the terminal finishes data transmission to the base station by elapsing the predetermined time period. Thus, when there is a lot of data to transmit to the base station, the terminal finishes data transmission to the base station before transmitting all of the data, and re-opens inter-terminal direct communication. Thus, the throughput for inter-terminal direct communication does not drop more than necessary due to transmitting data to the base station.

Also, each of the terminals includes a transmission amount judgment unit which judges whether or not the communication unit performs a predetermined amount of data transmissions to the wireless LAN base station; and the data transmission unit may finish transmitting data to the wireless LAN base station when the transmission amount judgment unit judges that the predetermined amount of data transmissions are performed during the data transmission to the wireless LAN base station.

With this structure, the terminal finishes data transmission to the base station when the amount of data transmissions reach a predetermined amount. Thus, when there is a lot of data to transmit to the base station, the terminal finishes data transmission to the base station before transmitting all of the data and re-opens inter-terminal direct communication. Thus, the throughput for inter-terminal direct communication does not drop more than necessary due to transmitting data to the base station.

Also, the communication unit may include: a channel switching unit which switches the wireless channels used in communication; and a finish notification unit which notifies the wireless LAN base station to finish inter-terminal direct communication after the channel switching unit switches the channel used in wireless communication from the second wireless channel to the first wireless channel.

With this structure, the base station can acknowledge that the terminal has finished inter-terminal direct communication. Thus, the base station can ascertain the processing conditions of the terminal connected by wireless link.

Also, the finish notification unit further may notify the terminal which is a communication peer, which performs inter-terminal direct communication to finish inter-terminal direct communication.

With this structure, the terminal on the receiving side can acknowledge that the transmission side terminal has finished inter-terminal direct communication. Thus, the receiving side terminal can switch the wireless channel used by the terminal to the wireless channel used by the base station without remaining in the wireless channel used in inter-terminal direct communication.

Also, the wireless terminal which performs communication with another terminal through a wireless LAN base station includes a communication unit which performs inter-terminal direct communication with another terminal, inter-terminal direct communication being communication that bypasses the wireless LAN base station and that uses a second wireless channel which differs from a first wireless channel, the first wireless channel being used in wireless communication with the wireless LAN base station.

With this structure, the wireless terminal according to the present invention performs inter-terminal direct communication with another terminal, which is communication that bypasses the base station, using the second wireless channel, which differs from the first wireless channel which is used in wireless communication with the base station. Thus, even when inter-terminal direct communication and communication between the base station and the other terminal are performed simultaneously, data transmission in inter-terminal direct communication and data transmission between the base station and another terminal can be performed in parallel since the wireless channels used differ. In other words, even when inter-terminal direct communication and communication between the base station and the other terminal are performed simultaneously, the throughput will not decrease. Thus, a high throughput for the wireless terminal according to the present invention can be realized, even when communications are performed among plural terminals.

Also, the communication unit includes a request transmission unit which transmits a request signal, which is a signal that requests inter-terminal direct communication be performed, to the wireless LAN base station, and the communication unit may perform inter-terminal direct communication with the terminal which is a communication peer, when a request in the request signal transmitted by the request transmission unit is permitted by the base station.

With this structure, the wireless terminal according to the present invention transmits the request signal for performing inter-terminal direct communication to the base station. Thus, the base station can ascertain the wireless terminal which performs inter-terminal direct communication as well as the wireless channel used in inter-terminal direct communication. Thus, the wireless link can be easily controlled by the base station.

Also, the communication unit may include a notification signal reception unit which receives a notification signal which is periodically transmitted by the wireless LAN base station and includes first channel information which is information about wireless channels compatible with another terminal, and the wireless terminal may further include a channel selection unit which selects the second wireless channel from among wireless channels compatible with the terminal which is a communication peer, which are included in the notification signal received by the notification signal reception unit.

With this structure, the wireless terminal according to the present invention can select the wireless channel used in inter-terminal direct communication using information about wireless channels compatible with the terminal which is a communication peer, which is included in the notification signal.

Also, the channel selection unit may select a wireless channel distanced at least two channels from the first wireless channel as the second channel.

With this structure, interference in the wireless channel proximal to the wireless channel used in inter-terminal direct communication can be reduced since a wireless channel proximal to the wireless channel used by the base station is not used in inter-terminal direct communication.

Also, the channel selection unit includes a use judgment unit which judges whether or not the wireless channel is in use, based on whether or not the notification signal is received in each wireless channel available for wireless communication; and the channel selection unit may select the wireless channel used in inter-terminal direct communication from the wireless channels judged to be available by the use judgment unit.

With this structure, the wireless terminal according to the present invention can select the wireless channel used in inter-terminal direct communication using a wireless channel that is not used by another base station and the like.

Also, the channel selection unit includes a measurement unit which measures the traffic density of each wireless channel available for wireless communication, and the channel selection unit may select the wireless channel to be used from among the wireless channels with the least amount of traffic density based on the measurement result by the measurement unit.

With this structure, the wireless terminal according to the present invention can select the wireless channel used in inter-terminal direct communication from the wireless channels with traffic density less than a predetermined value.

Also, a first channel information holding unit may hold channel information which is wireless channel information compatible with the terminal, and the communication unit includes a channel information transmission unit which may transmit the channel information held by the first channel information holding unit to the wireless LAN base station.

With this structure, the base station can select the wireless channel used in inter-terminal direct communication. Thus, the structure of the terminals can be simplified since the terminal does not need to be functional to select the wireless channel used in inter-terminal direct communication.

Also, the communication unit may include a notification signal reception unit which receives a notification signal which is transmitted periodically on the first wireless channel by the wireless LAN base station, the notification signal including timing information which is information about the timing for transmitting data by the base station; a channel switching unit which switches the wireless channel used in wireless communication from the second wireless channel to the first wireless channel on the timing based on the timing information included in the notification signal; and a data reception unit which receives data from the wireless LAN base station on the first wireless channel.

With this structure, when inter-terminal direct communication is performed using a different wireless channel from the wireless channel used by the base station, the wireless terminal according to the present invention can ascertain the timing by which data transmission from the base station is performed using the timing information included in the notification signal. Thus, the wireless terminal according to the present invention can easily receive data from the base terminal by switching the wireless channel according to the timing by which the base station performs data transmission.

Also, the communication unit may include a request transmission unit which transmits a request signal, which is a signal that requests inter-terminal direct communication be performed, to the terminal which is a communication peer; the communication unit performs inter-terminal direct communication with the terminal which is a communication peer when a request in the request signal transmitted by the request transmission unit is permitted by the terminal which is a communication peer.

With this structure, the wireless terminal according to the present invention can perform inter-terminal direct communication by transmitting the request to the terminal which is a communication peer to bypass the base station and directly perform inter-terminal direct communication. Thus, the process for starting inter-terminal direct communication can be streamlined compared to when the request to perform inter-terminal direct communication is transmitted through the base station.

Also, the communication unit further includes: a detection signal transmission unit which transmits a detection signal for detecting a terminal which can perform inter-terminal direct communication; and a terminal judgment unit which judges whether or not the terminal which is a communication peer can perform inter-terminal direct communication, based on a response from the terminal which is a communication peer to the detection signal transmitted by the detection signal transmission unit, and the request transmission unit may transmit the request signal to the terminal which is a communication peer when the terminal judgment unit judges that the terminal, which is a communication peer, can perform inter-terminal direct communication, and not to transmit the request signal to the terminal which is a communication peer when it is judged by the terminal judgment unit that the terminal, which is a communication peer, cannot perform inter-terminal direct communication.

With this structure, the wireless terminal according to the present invention can ascertain whether or not the terminal which is a communication peer is compatible with inter-terminal direct communication before transmitting the request signal to the terminal which is a communication peer. Thus, the wireless terminal according to the present invention can reduce the processing load without transmitting the request signal when the terminal which is a communication peer cannot perform inter-terminal direct communication.

Also, the communication unit includes a finish notification unit which notifies the terminal which is a communication peer to switch the wireless channel used in wireless communication from the second wireless channel to the first wireless channel when inter-terminal direct communication is finished, and the communication unit may switch the wireless channel used in wireless communication from the second wireless channel to the first wireless channel after the notification is issued by the finish notification unit.

With this structure, the wireless terminal according to the present invention notifies the terminal which is a communication peer that the wireless channel used will be changed to the first wireless channel when inter-terminal direct communication is finished. Thus, the terminal which is a communication peer can change to the first wireless channel, which is used by the base station, after inter-terminal direct communication is finished. In other words, the terminal which is a communication peer can finish inter-terminal direct communication without disconnecting the base station.

Also, the communication unit may include a communication state analysis unit which analyzes a communication state of the inter-terminal direct communication with the terminal which is a communication peer; and a communication continuation judgment unit which judges whether or not communication should be continued based on an analysis result of the communication state analysis unit.

With this structure, the wireless terminal according to the present invention can change channels to the first wireless channel and afterwards communicate with the base station when it is judged that communication should not be continued. Also, the wireless terminal according to the present invention can reduce wasted power consumption which occurs when communication is continued with a terminal which cannot communicate.

Also, the communication state analysis unit may include: a timer unit which counts a predetermined time period while inter-terminal direct communication is performed with the terminal which is a communication peer; and a calculation unit which calculates a number of packets transmitted or received using inter-terminal direct communication with the terminal which is a communication peer, while the predetermined time is counted by the timer unit, and the communication continuation judgment unit which judges that communication should be continued when the amount of packets counted by the calculation unit is greater than a predetermined value and that communication should be ended when the number of packets counted by the counting unit is smaller than the predetermined value.

With this structure, the wireless terminal according to the present invention can judge whether or not inter-terminal direct communication should be continued within each predetermined period. Thus, the wireless terminal according to the present invention can be judged efficiently in comparison to judging whether or not inter-terminal direct communication should be continued, at every transmission or every reception.

Also, the communication unit may further include: a detection signal transmission unit which transmits a detection signal for detecting a terminal which can perform inter-terminal direct communication to the terminal which is a communication peer when the communication continuation judgment unit judges that communication should be stopped; and a terminal judgment unit which judges whether or not the terminal which is a communication peer can perform inter-terminal direct communication based on the response from the terminal which is a communication peer to the detection signal transmitted by the detection signal transmission unit, and the communication unit is operable to finish the inter-terminal direct communication with the terminal which is a communication peer when the terminal judgment unit judges that the terminal which is a communication peer cannot perform inter-terminal direct communication.

With this structure, the wireless terminal according to the present invention can judge whether or not the terminal which is a communication peer can accept a control system frame and so on by confirming the response of the terminal which is a communication peer to the detection signal when it is judged that communication should be finished. Thus, when the terminal which is a communication peer temporarily cannot communicate for some reason, inter-terminal direct communication can be continued. In other words, the communication state can be judged more reliably.

Also, the communication unit further includes an acknowledgement judgment unit which judges whether or not an acknowledgement signal for the detection signal from the terminal which is a communication peer is received when the inter-terminal judgment unit judges that the terminal which is a communication peer cannot perform inter-terminal direct communication; the detection signal transmission unit may re-transmit the detection signal to the terminal which is a communication peer when the acknowledgement judgment unit judges that the acknowledgement signal is received, and the communication unit finishes inter-terminal direct communication with the terminal which is a communication peer when it is judged by the acknowledgement judgment unit that the acknowledgement signal is not received.

With this structure, the wireless terminal according to the present invention judges whether or not the wireless conditions are temporarily worsened by judging whether the ACK signal has been received from the terminal which is a communication peer. When the wireless conditions are temporarily poor, the wireless terminal according to the present invention transmits the detection signal again. By doing so, the wireless terminal according to the present invention can continue transmission when the wireless conditions improve. In other words, the judgment of whether or not to continue the communication can be done more reliably.

Also, the communication unit further includes a timer unit which counts the predetermined time period, after the acknowledgement judgment unit judges that the acknowledgement signal is received; and the detection signal transmission unit may re-transmit the detection signal to the terminal which is a communication peer after the predetermined time period is counted by the timer unit.

With this structure, when cellular conditions temporarily worsen, the wireless terminal according to the present invention transmits the detection signal to the terminal which is a communication peer after a predetermined amount of time. Thus, the wireless terminal according to the present invention can improve efficiency since the transmission of wasted detection signals can be reduced.

Also, a wireless communication method for a wireless communication system which includes a wireless LAN base station, in which plural terminals mutually communicate through the wireless LAN base station, each of the terminals performing inter-terminal direct communication with an other terminal, using a second wireless channel that is different from a first wireless channel, the first wireless channel being used in wireless communication with the base station, inter-terminal direct communication being communication that bypasses said wireless LAN base station.

Thus, even when inter-terminal direct communication and communication between the base station and the other terminal are performed simultaneously, data transmission in inter-terminal direct communication and data transmission between the base station and the other terminal can be performed in parallel since the wireless channels used differ. In other words, even when inter-terminal direct communication and communication between the base station and the other terminal are performed simultaneously, the throughput will not decrease. Thus, the wireless communication method according to the present invention can realize a high throughput even when communications are performed among plural terminals.

The present invention can provide a wireless communication system, a wireless terminal and a wireless communication method which can realize a high throughput even when communications are performed between plural terminals.

As further information about the technical background to this application, the following applications are disclosed:
Japanese Patent Application No. 2006-087747 filed on Mar. 28, 2006; and
Japanese Patent Application No. 2007-69404 filed on Mar. 16, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram which shows the structure of a conventional wireless LAN system and a data communication flow;

FIG. 2 is a diagram which shows the communication time period during data transmission in the conventional wireless LAN system;

FIG. 3 is a diagram which shows the structure of a wireless LAN system and a data communications flow for performing conventional inter-terminal direct communication;

FIG. 4 is a diagram which shows the communication time when the data is transmitted in conventional inter-terminal direct communication;

FIG. 5 is a diagram which shows the data flow when inter-terminal direct communication and data communication via the access point are performed simultaneously in the conventional LAN system;

FIG. 6 is a diagram which shows the communication time in data transmission when inter-terminal direct communication and data communication via the access point are performed simultaneously in the conventional LAN system;

FIG. 7 is a block diagram which shows a structure of the wireless communication system in the present embodiment;

FIG. 8 is a diagram which shows the communication time for data transmission in the wireless system according to the present embodiment;

FIG. 9 is a block diagram which shows the structure of a terminal according to the present embodiment;

FIG. 10 is a block diagram which shows the structure of an access point according to the present embodiment;

FIG. 11 is a diagram which shows a process flow of inter-terminal direct communication in the wireless communication system according to the present embodiment;

FIG. 12 is a diagram which shows a Beacon transmission process in the wireless communication system according to the present embodiment;

FIG. 13 is a diagram which shows the structure of an IE which displays terminal support channel information included in the Beacon;

FIG. 14 is a diagram which shows an example of a SCAN process;

FIG. 15 is a diagram which shows a frequency region utilized by the wireless channel;

FIG. 16 is a diagram which shows a signal flow for a process of measuring the traffic density of the wireless channel using DFS;

FIG. 17 is a diagram which shows a process for issuing a notification that a terminal which performs inter-terminal direct communication changes channels using DLS;

FIG. 18 is a diagram which shows an example of an extended DLS-Request frame format used in the channel change notification;

FIG. 19 is a diagram which shows an example of the format of the channel selection IE included in channel change information;

FIG. 20 is a diagram which shows an example of the format of the channel selectable IE included in the channel change information;

FIG. 21 is a diagram which shows a channel change notification process flow that uses an Association;

FIG. 22 is a diagram which shows the structure of an association frame format utilized in the channel change notification;

FIG. 23 is a diagram which shows an example of the IE structure which includes the channel change information;

FIG. 24 is a diagram which shows an inter-terminal direct communication process flow when the access point determines the wireless channel used in inter-terminal direct communication;

FIG. 25 is a diagram which shows a wireless channel change process that uses a countdown method that utilizes a Beacon;

FIG. 26 is a diagram which shows a wireless channel change process which relays a synchronization signal for changing channels between terminals which perform inter-terminal direct communication;

FIG. 27 is a diagram which shows the process of transmitting a QoS-CF-Poll frame in HCCA;

FIG. 28 is a diagram which shows a process in which the access point changes the wireless channel and transmits the Beacon;

FIG. 29 is a diagram which shows the process of the terminal which performs inter-terminal direct communication changing the wireless channel and receiving the Beacon;

FIG. 30 is a diagram which shows the process when the terminal performing inter-terminal direct communication performs communication with the access point;

FIG. 31 is a diagram which shows a Beacon information IE structure;

FIG. 32 is a diagram which shows the process of transmitting data from the terminal that performs inter-terminal direct communication to the access point;

FIG. 33 is a flowchart which shows a first process flow for judging whether the data transmitted from the terminal to the access point has finished;

FIG. 34 is a flowchart which shows a second process flow for judging whether the data transmitted from the terminal to the access point has finished;

FIG. 35 is a flowchart which shows a third process flow for judging whether the data transmitted from the terminal to the access point has finished;

FIG. 36 is a diagram which shows the structure of an extended PS-Poll frame;

FIG. 37 is a diagram which shows the process of the access point changing the wireless channel and receiving the Beacon from the terminal;

FIG. 38 is a diagram which shows the process of the terminal, which has been performing inter-terminal direct communication, stopping the communication;

FIG. 39 is a diagram which shows a transformation of the process in which the terminal, which performs inter-terminal direct communication, stops the communication;

FIG. 40 is a flowchart which shows a process flow of determining a method for issuing an inter-terminal direct communication request;

FIG. 41 is a diagram which shows a process flow for issuing a channel change notification using a unique frame;

FIG. 42 is a diagram which shows the structure of an inter-terminal direct communication request frame;

FIG. 43 is a diagram which shows the structure of the inter-terminal direct communication response frame;

FIG. 44 is a diagram which shows the inter-terminal direct communication process flow of terminal 102;

FIG. 45 is a diagram which shows the structure of an inter-terminal direct communication estimation frame which uses a Probe Request frame;

FIG. 46 is a diagram which shows the structure of an inter-terminal direct communication detection response frame which uses a Probe Response frame;

FIG. 47 is a diagram which shows a process in which the terminal which performs inter-terminal direct communication stops communication using an inter-terminal direct communication cancellation request frame;

FIG. 48 is a diagram which shows the structure of the inter-terminal direct communication cancellation request frame;

FIG. 49 is a flowchart which shows the judgment process flow for the communication state;

FIG. 50 is a flowchart which shows a modification of the flow of the judgment process for the communication status;

FIG. 51 is a flowchart which shows a modification of the flow of the judgment process for the communication status;

FIG. 52 is a flowchart which shows a modification of the flow of the judgment process for the communication status; and

FIG. 53 is a flowchart which shows a modification of the flow of the judgment process for the communication status.

### DESCRIPTION OF THE PREFERRED EMBODIMENT(S)

Below, an embodiment of a wireless communication system according to the present invention is described in detail with reference to the drawings.

In the wireless communication system according to the present embodiment, a terminal performs inter-terminal direct communication using a different wireless channel than a wireless channel utilized by an access point. Thus, inter-terminal direct communication by the terminal can be performed in parallel with communication between the terminal, a different terminal and the access point. Therefore, since the throughput of the wireless communication system according to the present embodiment does not drop even when communications are performed between plural terminals, a high throughput can be realized.

First, the structure of the wireless communication system in the present embodiment is described.

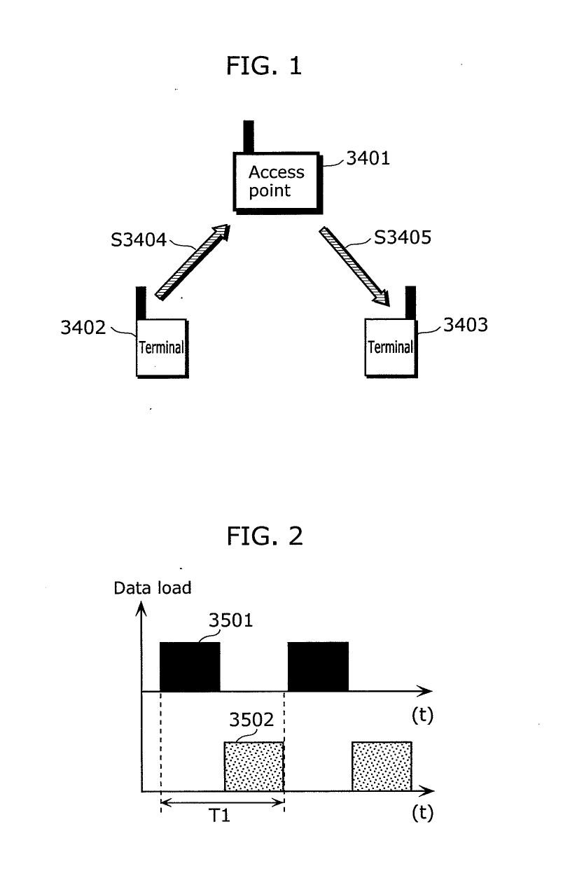

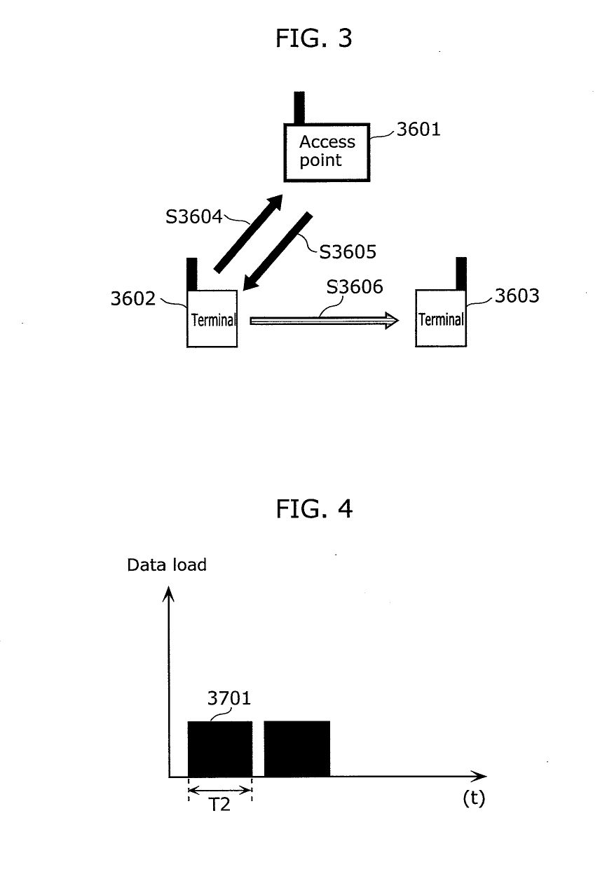

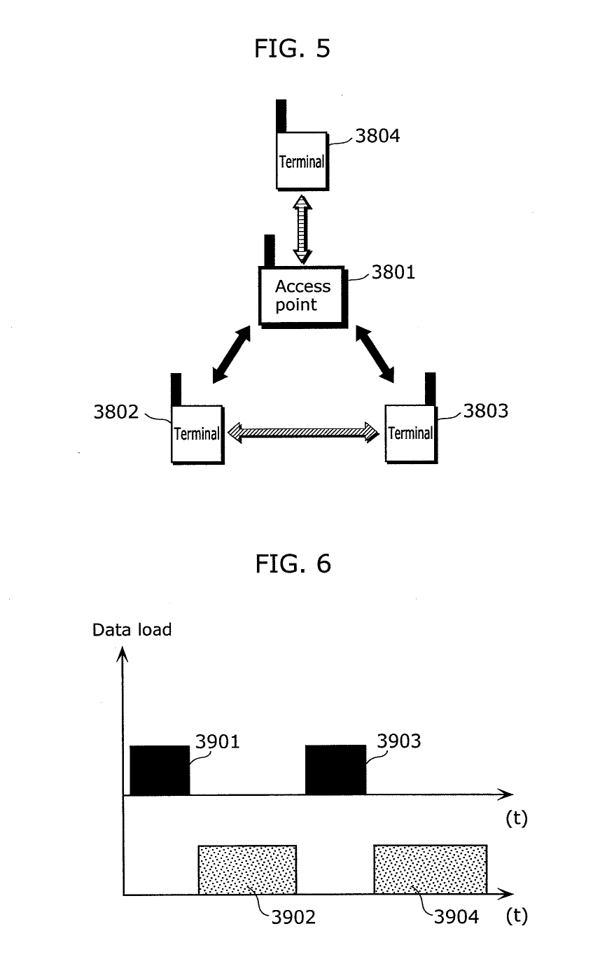

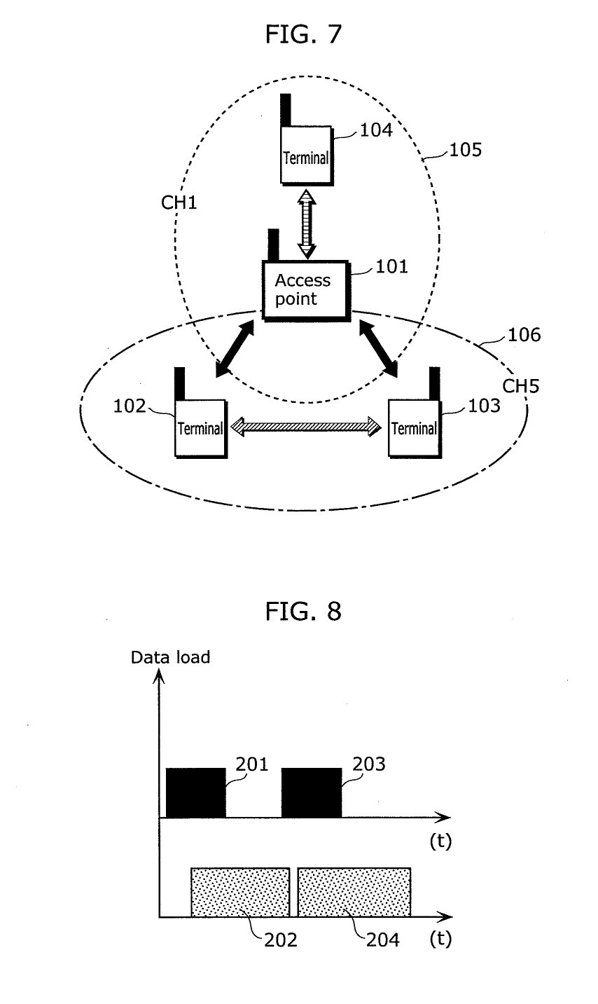

FIG. 7 is a diagram which shows a typical structure of the wireless communication system according to the present embodiment. The wireless communication system shown in FIG. 1 includes an access point 101, a terminal 102, a terminal 103 and a terminal 104. In the wireless communication system shown in FIG. 7, data communication is performed between the access point 101, terminal 102, terminal 103 and terminal 104. The wireless communication system shown in FIG. 7 is, for example, a wireless communication system that utilizes a wireless LAN.

The access point 101 is a wireless LAN base station which performs control for the entire wireless communication system. For example, the access point 101 is a router and so on with a wireless communication function. Note that the access point 101 may be an AV device with a wireless communication function (a DVD player, a DVD recorder, an AV server and so on), a personal computer and so on.

Terminal 102, terminal 103 and terminal 104 perform data communication with another terminal via the access point 101 using the wireless LAN. Or, terminal 102, terminal 103 and terminal 104 perform inter-terminal direct communication with the other terminal using the wireless LAN without passing via the access point 101. Or, terminal 102, terminal 103 and terminal 104 utilize a wireless channel different from the wireless channel utilized by the access point 101 in inter-terminal direct communication. Here, the wireless channel is split into frequency bands which are utilized in wireless LAN communication, and the split frequency bands are called “channels”. For example, terminal 102, terminal 103 and terminal 104 are PCs and the like which have built-in wireless LAN communication functions, or are equipped with a wireless LAN card. Note that terminal 102, terminal 103 and terminal 104 may be an information home appliance such as a TV receiver, a DVD recorder, a DVD player and an AV device equipped with a wireless communication function, as well as a cordless phone and so on. Note that the amount of terminals included in the wireless communication system in FIG. 7 is three, and when there are plural terminals, at least 3 terminals are included.

Below, a case is described in which inter-terminal direct communication is performed between terminal 102 and terminal 103 and simultaneously, communication is performed between the access point 101 and terminal 104 in the wireless communication system shown in FIG. 7.

FIG. 8 is a diagram which shows the amount of communication time when inter-terminal direct communication is performed between terminal 102 and terminal 103 and simultaneously, communication is performed between the access point 101 and terminal 104. Inter-terminal direct communication between terminal 102 and terminal 103, and communication between the access point 101 and terminal 104 are performed using different wireless channels, and as shown in FIG. 8, an inter-terminal direct communication 202 between terminal 102 and terminal 103, and a communication 201 between the access point 101 and terminal 104 can be performed in parallel. Thus, the throughput does not drop, even when communications are performed among plural terminals. For example, a wireless channel 106 utilized in the inter-terminal direct communication between terminal 102 and terminal 103 is channel 5 (CH5) and a wireless channel 105 utilized in communication between the access point 101 and terminal 104 is channel 1 (CH1).

Next, the structure of terminal 102 and the access point 101 in the wireless communication system shown in FIG. 7 is described below.

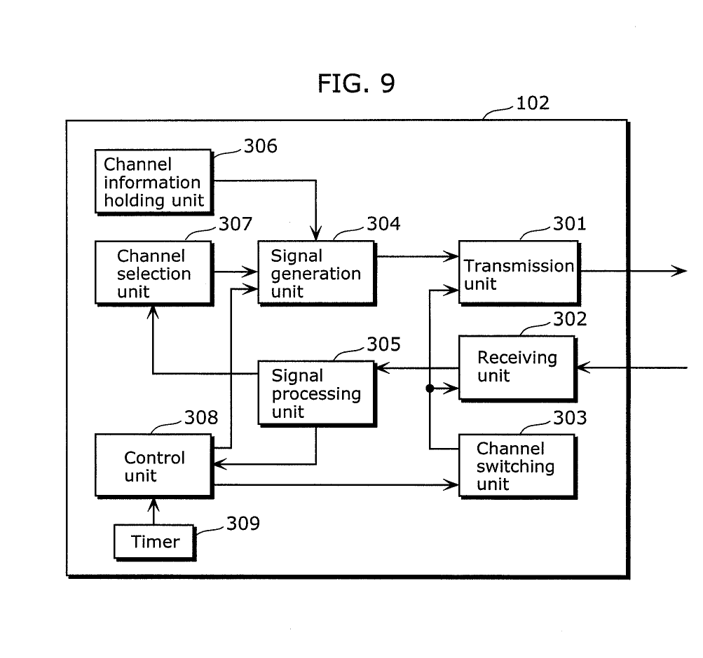

FIG. 9 is a block diagram which shows a typical structure of terminal 102, as shown in FIG. 7. Note that terminal 103 and 104 have the same structure as the structure in FIG. 9.

Terminal 102 as shown in FIG. 9 includes a transmission unit 301, a reception unit 302, a channel switching unit 303, a signal generation unit 304, a signal processing unit 305, a channel information holding unit 306, a channel selection unit 307, a control unit 308 and a timer 309.

The transmission unit 301 transmits data and a signal to the access point 101, terminal 103 and terminal 104 via wireless LAN communication.

The reception unit 302 receives the data and the signal transmitted from the access point 101, terminal 103 and terminal 104.

The channel switching unit 303 switches a wireless channel utilized in transmission by the transmission unit 301 and a wireless channel utilized in reception by the reception unit 302.

The signal generation unit 304 generates a signal which is utilized in an authentication process performed when establishing a wireless link with the access point 101, as well as a request signal for inter-terminal direct communication and so on.

The signal processing unit 305 processes the signal received by the reception unit 302.

The channel information holding unit 306 holds information about wireless channels supported by and compatible with terminal 102.

The channel selection unit 307 selects the wireless channel utilized in inter-terminal direct communication.

The control unit 308 controls the channel switching unit 303, the signal generation unit 304 and so on.

The timer 309 counts a predetermined time period.

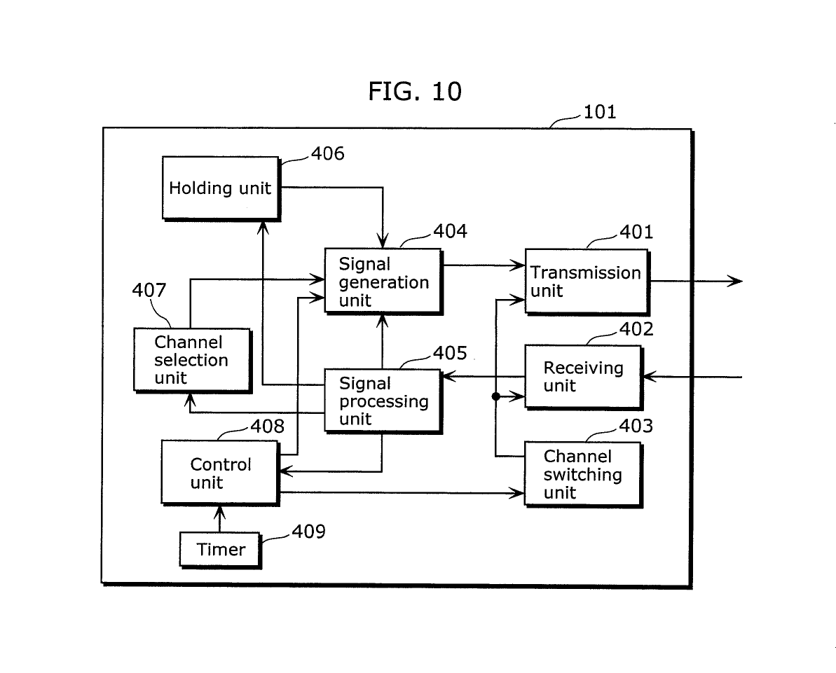

FIG. 10 is a block diagram which shows a typical structure of the access point 101 shown in FIG. 7.

The access point 101 shown in FIG. 10 includes a transmission unit 401, a reception unit 402, a channel switching unit 403, a signal generation unit 404, a signal processing unit 405, a holding unit 406, a channel selection unit 407, a control unit 408 and a timer 409.

The transmission unit 401 transmits data and a signal to terminals 102, 103 and terminal 104 via wireless LAN communication.

The reception unit 402 receives the data and the signal transmitted from the terminal 102, terminal 103 and terminal 104.

The channel switching unit 403 switches a wireless channel utilized in transmission by the transmission unit 401 and a wireless channel utilized in reception by the reception unit 402.

The signal generation unit 404 generates a signal such as a Beacon, which is a notification signal.

The signal processing unit 405 processes the signal received by the reception unit 402.

The holding unit 406 holds information about wireless channels supported by terminal 102, 103 and 104.

The channel selection unit 407 selects the wireless channel utilized in inter-terminal direct communication.

The control unit 408 controls the channel switching unit 403 and the signal generation unit 404.

The timer 409 counts the predetermined time period.

Next, the processes of the wireless communication system in the present embodiment are described.

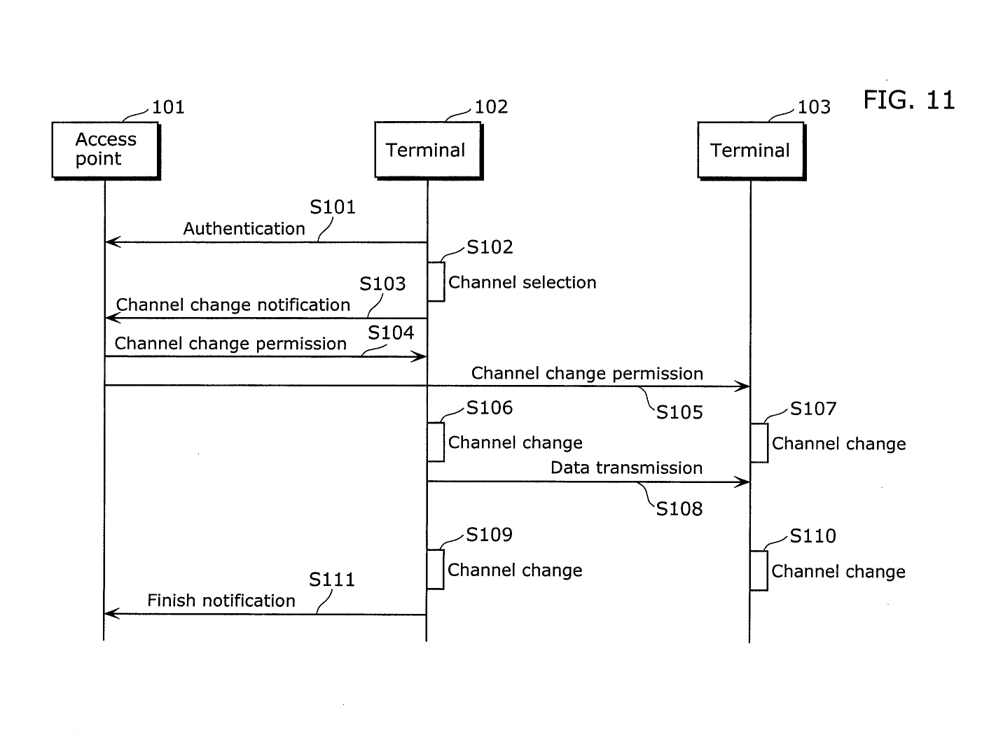

FIG. 11 is a diagram which shows the process of data transmission in the wireless communication system according to the present embodiment. FIG. 11 is a diagram which shows the process when terminal 102 transmits data to terminal 103 using inter-terminal direct communication.

First, terminal 102 receives the notification signal (Beacon) which is regularly transmitted by the access point 101 and acknowledges the access point 101 as unable to perform wireless communication. After terminal 102 acknowledges the access point 101, terminal 102 transmits the wireless channel information that terminal 102 supports, which is held in the channel information holding unit 306, to the access point 101 and performs authentication (S101). The access point 101 authenticates terminal 102 as a terminal capable of communication using information of terminal 102 transmitted from terminal 102.

Terminal 102 acquires wireless channel information supported by terminal 103, which is the data destination address from the Beacon and so on sent by the access point 101. Terminal 102 searches for a wireless channel not currently in utilize. Terminal 102 determines the wireless channel to be utilized in communication with terminal 103, using information in the wireless channel compatible with terminal 103, as well as information in the wireless channel not currently in utilize (S102).

Terminal 102 transmits the request signal which is a signal that requests inter-terminal direct communication to the access point 101. Terminal 102 issues a notification of the wireless channel information determined to the access point 101 in Step 102 (S103).

When the access point 101 permits terminal 102 and terminal 103 to perform inter-terminal direct communication in the wireless channel notified, terminal 102 and terminal 103 are permitted to change the wireless channel (S104 and S105). Here, “changing the wireless channel” means switching the wireless channel utilized in the wireless signal and is utilized below in the same meaning.

When terminal 102 receives change permission from the access point 101, terminal 102 changes to the wireless channel designated (S106). When terminal 103 receives change permission from the access point 101, terminal 103 changes to the wireless channel to which terminal 102 has changed (S107).

After the wireless channel is changed, terminal 102 transmits data to terminal 103 (S108). After the data is transmitted, terminal 102 changes to the wireless channel utilized by the access point 101 (S109). After the data is transmitted from terminal 102, terminal 103 changes to the wireless channel utilized by the access point 101 (S110).

Terminal 102 issues a notification to the access point 101 that the inter-terminal direct communication with terminal 103 has finished (S111) after the channel is changed (S109).

As shown above, when terminal 102 transmits data to terminal 103 in the wireless communication system in the present embodiment, terminal 102 and terminal 103 change to a wireless channel different from the wireless channel with which the access point 101 is communicating, and perform inter-terminal direct communication. Thus, inter-terminal direct communication between terminal 102 and terminal 103 and communication between the access point 101 and terminal 104 can be performed in parallel.

Next, the processes of the wireless communication system in the present embodiment are described in detail.

First, a channel selection process in Step S102 in FIG. 11 is described.

The wireless channel utilized in inter-terminal direct communication must be supported by both wireless terminals which perform inter-terminal direct transmission. In the case where a wireless channel that is not supported by one of the terminals is selected as the wireless channel for inter-terminal direct communication, the wireless terminal cannot change channels and a result cannot perform inter-terminal direct communication. Accordingly, mutually supported channel information must be known in order to avoid this problem. For that purpose, both terminals can obtain information about wireless channels supported by both terminals by displaying information about compatibility with the channel communication in the notification signal (Beacon), which is regularly received by both terminals.

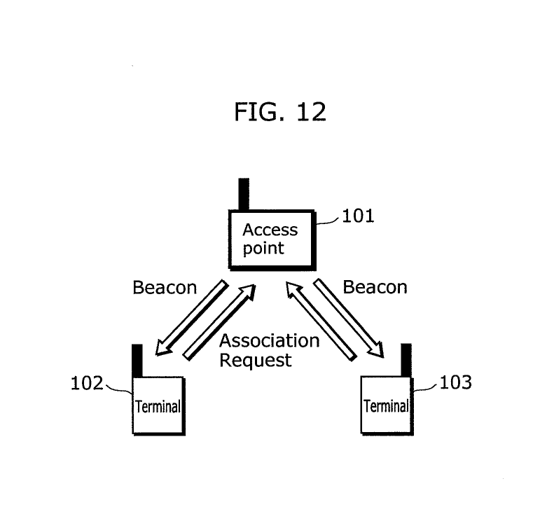

FIG. 12 is a diagram which shows a typical flow of signals in the process of transmitting the Beacon from the access point 101. When the connection type is Basic Service Set (BSS) type, in which the access point 101 manages the wireless network itself, as shown in FIG. 12, the access point 101 transmits the Beacon. The signal generation unit 404 in the access point 101 generates a Beacon which includes information about wireless channels compatible with each of the terminals 102 through 104, which have established wireless links with the access point 101. When the count value counted by the timer 409 reaches a predetermined value, the signal generation unit 404 is controlled by the control unit 408 to transmit the generated Beacon to terminal 102, terminal 103 and terminal 104 via the transmission unit 401. In other words, the signal generation unit 404 periodically transmits the generated Beacon. Terminal 102 and terminal 103 regularly receive the Beacon. For example, transmitting the Beacon from the access point 101 is performed at a period of 200 ms. The signal generation unit 404 in the access point 101 prepares terminal support channel information as one Information Element (IE) to be included in the Beacon, and incorporates information about wireless channels supported by the terminals connected via wireless link; this way, each terminal can obtain information about wireless channels supported by the terminal connected via wireless link. Here, the information about wireless channels supported by each terminal is transmitted to the access point 101 when an Association procedure (authentication procedure) is performed, the authentication procedure being one of the procedures utilized when each terminal establishes a wireless link with the access point in Step S101 as shown in FIG. 11. More specifically, the signal generation unit 304 in terminal 102, which performs the association procedure, generates a signal which includes information about wireless channels supported by the terminal 102, which is held by the channel information holding unit 306. The transmission unit 301 transmits the signal generated by the signal generation unit 304 to the access point 101. The signal processing unit 405 in the access point 101 holds the received information about wireless channels supported by terminal 102 in the holding unit 406. Here, the access point 101 acquires information about wireless channels supported by the other terminal 103 and terminal 104 by performing an authentication process when terminals 103 and 104 establish a wireless link, and stores the wireless channel information in the holding unit 406. The signal generation unit 404 generates the Beacon which includes the IE which in turn includes information about the wireless channels supported by each terminal, which is held by the holding unit 406.

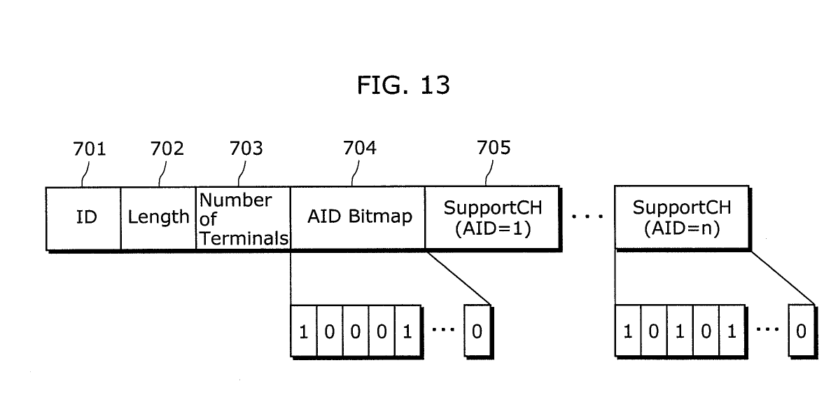

FIG. 13 is a diagram which shows the structure of an IE which includes terminal support channel information included in the Beacon. The IE shown in FIG. 13 includes an ID701 for the IE, an IE length 702, a number of terminals connected 703, an AID (Association ID) bitmap 704, and a number of support channel bitmaps 705 equal to the number of terminals connected.

The ID 701 is an identifier for identifying the type of the IE, and may use a value undefined in IEEE802.11. The Length 702 expresses length information for the IE.

The number of connected terminals 703 expresses the number of wireless terminals connected to the access point 101. For example, in the wireless communication system shown in FIG. 7, the number of connected terminals 703 is “3”.

The AID bitmap 704 is a bitmap which shows information about terminals which have established a wireless link with the access point 101. An AID is allocated when the wireless terminal establishes a wireless link with the access point 101. Thus, each wireless terminal can be identified by its AID. The AID bitmap is a display of the AIDs for wireless terminals currently connected. For example, when a wireless terminal with an AID=1 and a wireless terminal with an AID=5 are connected with the access point 101, the 1^{st} bit and the 5^{th} bit in the AID bitmap are made valid.

The number of terminals which have established wireless links with the access point 101 is provided in the support channel bitmap 705. Also, the support channel bitmap 705 is laid out in the order of valid AIDs on the AID bitmap. In the structure of the support channel bitmap 705, the portion of the bitmap showing the channels supported by the wireless terminal is made valid. For example, bit 1, bit 3 and bit 5 are made valid in the support channel bit map of the wireless terminal, which supports channel 1, channel 3 and channel 5.

In this way, the wireless communication system in the present embodiment transmits information about wireless channels available for inter-terminal direct communication by the access point 101 to each terminal via the Beacon. Thus, each terminal can obtain information about channels available by the data destination address terminal.

Next, the channel selection unit 307 in the data sending address terminal 102 selects the channel actually utilized among the channels available by the data destination address terminal 103. The wireless channel utilized in inter-terminal direct transmission must be a wireless channel that is not used by another wireless terminal. Thus, in order to search ahead of time for a wireless channel that is in use, terminal 102 performs a SCAN process and retrieves a usage status of the wireless channel.

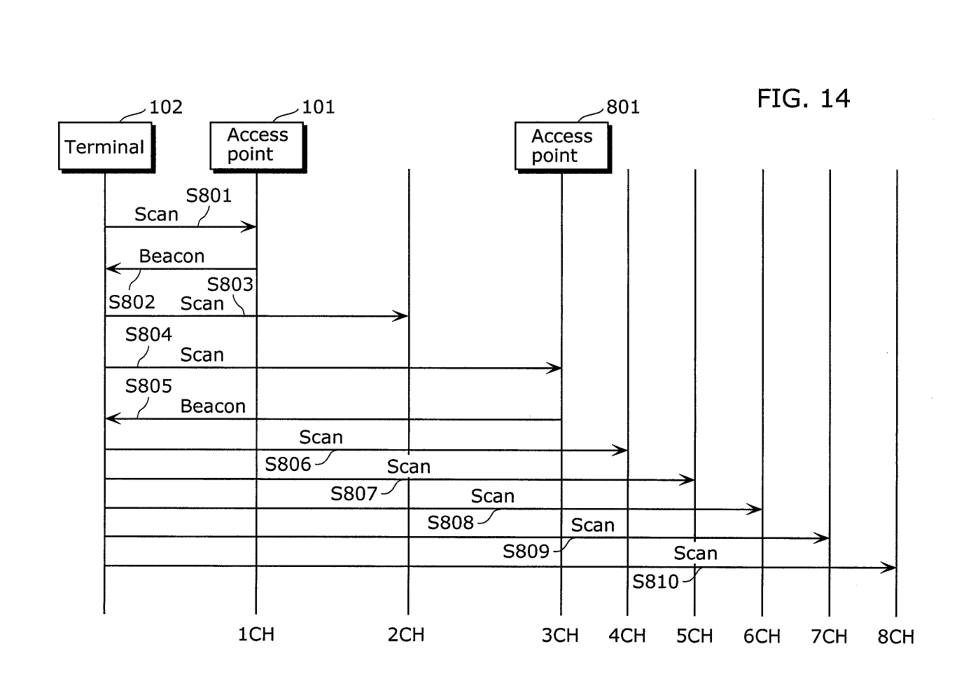

FIG. 14 is a diagram which shows an example of the SCAN process performed by the terminal. FIG. 14 is a diagram which shows the SCAN process performed by terminal 102 when channel 1 and channel 3 are utilized among eight wireless channels utilized in wireless communication that uses the wireless LAN.

Terminal 102 shown in FIG. 14 judges whether or not the wireless channel is in use based on whether or not the Beacon is received in each wireless channel available for wireless communication (channel 1 through 8). First, terminal 102 scans channel 1 (S801). More specifically, the control unit 308 controls the channel switching unit 303 in terminal 102 to switch the wireless channel used by the reception unit 302 for reception to channel 1. Thus, the reception unit 302 receives a signal in the frequency area of channel 1. Since the access point 101 uses channel 1, the reception unit 302 in terminal 102 receives the Beacon regularly transmitted by the access point 101 (S802). The received Beacon is processed by the signal processing unit 305 and the control unit 308 acknowledges that channel 1 is not available. Next, terminal 102 scans channel 2 in the same way as channel 1 (S803). Since channel 2 is an available channel, the reception unit 302 in terminal 102 does not receive the Beacon transmitted by an access point. Thus, the control unit 308 in terminal 102 acknowledges that channel 2 is an available channel. Next, terminal 102 scans channel 3 (S804). Since the access point 801 uses channel 3, the reception unit 302 in terminal 102 receives the Beacon regularly transmitted by the access point 801 and acknowledges that channel 3 is unavailable. In the same way below, terminal 102 scans channels 4 through 8 (S806 through S810) and acknowledges that channels 4 through 8 are available channels. By performing the SCAN process above, terminal 102 acknowledges that channel 2 and 4 through 8 are available. When using a channel proximal to a channel used by the access point, the channel used in inter-terminal direct communication and the channel used by the access point may cause interference, which may have a great effect on the throughput.

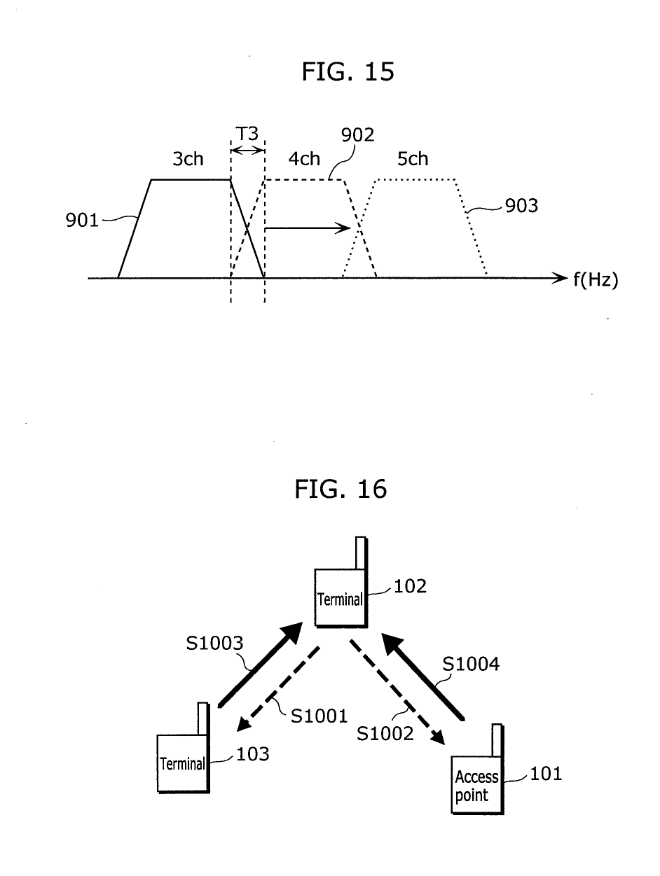

FIG. 15 is a diagram which shows a frequency region utilized by each channel. For example, as shown in FIG. 15, a frequency region 901 of channel 3 utilized by the access point 801 and a frequency region 902 of the proximal channel 4 may experience interference in the frequency region T3. Therefore, when the channel used in inter-terminal direct communication is determined to be a channel other than channels 2 and 4 which are proximal to channel 3, channel 3 being utilized by the access point 801, the problem of interference from a proximal channel can be avoided.

The channel selection unit 307 in terminal 102 is compatible with terminal 103, is a wireless channel judged to be available by the SCAN process, and selects a wireless channel utilized in inter-terminal direct communication from among wireless channels distanced two channels and above from the wireless channel in use. For example, in the scan process example shown in FIG. 14, terminal 102 and terminal 103 are compatible with channels 1 through 8 and the channel selection unit 307 in terminal 102 selects a channel besides channel 2 and 4 which is proximal to the in-use channel 1 and channel 3. In other words, the channel selection unit 307 in terminal 102 selects one of channel 5 through 8.

Therefore, terminal 102 in the wireless communication system according to the present embodiment, which is the data sending address, acquires wireless channel information compatible with the data destination address, terminal 103, from a Beacon, which is regularly transmitted by the access point 101. Also, the data sending address terminal 102 searches for an available channel by performing a SCAN process. Thus, terminal 102 can determine a channel to be utilized in inter-terminal direct transmission from among channels supported by and available to terminal 103.

Note that an example is shown above in which only the access point in FIG. 14 uses the wireless channel, however when a terminal which has established a wireless link with the access point 101 or 801 uses a wireless channel different from the wireless channel used by the access point 101 and 801 (channel 1 and 3) to perform inter-terminal direct communication, the access points 101 and 801 transmit a Beacon including information about wireless channels used in inter-terminal direct communication. Thus, terminal 102 can ascertain the wireless channel used in inter-terminal direct transmission from the Beacon received in the SCAN process.

Also, as a method for judging the wireless channel in use, besides the SCAN process, Dynamic Frequency Selection (DFS) may be used as a method of searching for a wireless channel. DFS is a specification which has been developed in order to prevent interference between channels by estimating the traffic density of the original wireless channel and changing to the wireless channel with traffic density less than a predetermined value. DFS can be used when terminal 102 which performs inter-terminal direct transmission determines a channel to change to.

FIG. 16 is a diagram which shows a typical flow of signals in the estimation process for estimating the traffic density of the wireless channel using DFS.

Terminal 102 estimates the traffic density of each available wireless channel in wireless communication using DFS. First, in order for terminal 102 to perform DFS, the channel is changed by a certain period and the usage condition of the wireless channel is checked. In order to check the usage state of the wireless channel, terminal 102 must have a function such as detecting carrier sense.

When terminal 102 does not have a function such as detecting carrier sense, terminal 102 issues an estimation request to terminal 103 or the access point 101 to check the wireless usage state, which have a function such as detecting carrier sense (S1001, S1002). Terminal 103 or the access point 101 estimate the usage condition of every channel which can be changed to. Terminal 103 or the access point 101 notifies terminal 102 of the estimation result (S1003, S1004). The channel selection unit 307 in terminal 102 selects the wireless channel to be used from wireless channels with little traffic density in the notified estimation result. In other words, the channel selection unit 307 in terminal 102 is a wireless channel supported by the data destination address terminal 103, and selects a wireless channel to be used in inter-terminal direct communication from among wireless channels with little traffic density.

Next, the process of transmitting the request for terminal 102 to perform inter-terminal direct communication, as well as the channel change notification process (Step S103 through S105 in FIG. 11), are explained in detail.

First, a method is described which allows terminal 102 to notify the access point 101 of the request to perform inter-terminal direct communication and information about wireless channels used in inter-terminal direct communication.

The access point 101 can ascertain the presence of a terminal that performs inter-terminal direct communication since terminal 102, which performs inter-terminal direct communication, notifies the access point 101 to perform inter-terminal direct communication. Thus, the access point 101 can display information about the terminal which performs inter-terminal direct communication and wireless channel information and so on used in inter-terminal direct communication in a notification signal such as the Beacon.

Direct Link Setup (DLS), as defined in the IEEE802.11e specifications, can be used as a means of notifying the access point 101 of information about wireless channels used in the request for inter-terminal direct communication and in inter-terminal direct communication. DLS is a method stipulated for performing negotiation with an access point when the terminal performs inter-terminal direct communication. The terminal which performs inter-terminal direct communication can perform inter-terminal direct communication first by obtaining permission from the access point. When this stipulation is applied in the same way when inter-terminal direct communication is performed using a different wireless channel from the wireless channel used by the access point, the access point can ascertain terminal information for changing channels before the terminal which performs inter-terminal direct communication changes the channel.

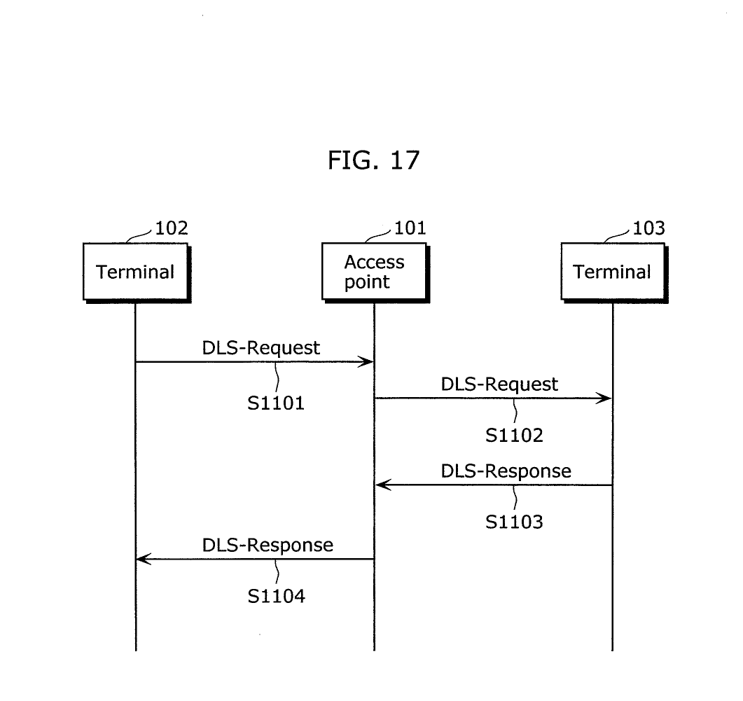

FIG. 17 is a diagram which shows a process for issuing a notification that the terminal which performs inter-terminal direct communication changes channels using DLS. The procedure between the access point 101 and terminal 102 is performed in a sequence according to the IEEE802.11e specifications. Terminal 102, which performs inter-terminal direct communication, requests the access point 101 to perform inter-terminal direct communication using a DLS-Request IE. First, the signal generation unit 304 in terminal 102 generates a DLS-Request frame, and issues the request for inter-terminal direct communication by transmitting the DLS-Request frame to the access point 101 via the transmission unit 301 (S1101). The access point 101 transmits the DLS-Request frame, transmitted from terminal 102, to terminal 103 (S1102). Terminal 103 receives the DLS-Request frame and transmits a DLS-Response frame to the access point 101 which indicates whether or not the wireless channel can be changed to the designated wireless channel (S1103). The access point 101 transmits to terminal 102 the DLS-Response frame, which permits changing channels to the wireless channel designated, when changing to the wireless channel designated by terminal 103 is permitted (S1104). According to the above processes, terminal 102 can notify the access point 101 of information about the destination channel. However, since there is no method for making notification of the channel change by inter-terminal direct communication in conventional specifications, the frame format which notifies the access point 101 of the DLS procedure must be extended. Note that in the above explanation, after the DLS-Response frame has been received from terminal 103, the access point 101 judges whether or not to permit channel changing to the designated wireless channel, after the DLS-Request frame has been received from terminal 102 (after Step S 101), and before the DLS-Request frame is transmitted to terminal 103 (before Step S1102), the access point 101 may judge whether or not to permit changing to the designated wireless channel.

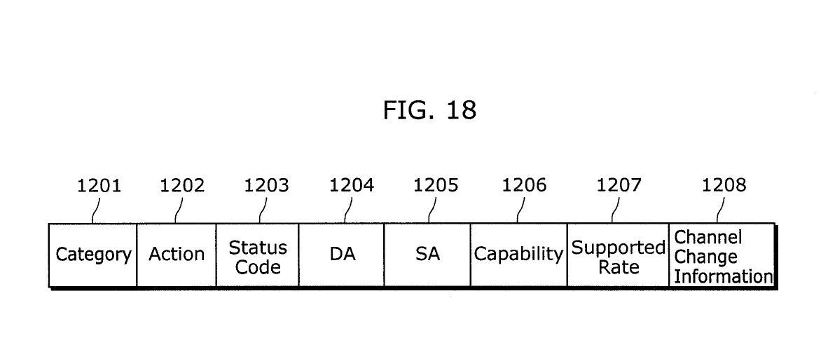

FIG. 18 is a diagram which shows an example of an extended DLS-Request frame format used in the channel change notification. The frame format shown in FIG. 18 includes Category 1201, Action 1202, Status Code 1203, Destination Address 1204, Sending address 1205, Capability 1206, Supported Rate 1207 and Channel change information 1208.

Category 1201 and Action 1202 are identifier codes which express a type of frame code, for example, the frame code is information such as a DLS-Request.

Status Code 1203 is the response from the destination address terminal 103, for example, information in response to the DLS-Request, such as permission to change the channel.

The destination address 1204 is a Medium Access Control (MAC) address for the frame code destination address terminal 103 or the access point 101 and is the MAC address for terminal 103 in FIG. 17.

The sending address 1205 is the MAC address for the frame code sending address, terminal 102 or the access point 101, and is the MAC address for terminal 102 in FIG. 17.

Capability 1206 is a bitmap included in the destination address terminal 103 and is information such as a cryptogram supported by terminal 103.

Supported Rate 1207 is wireless channel information compatible with the destination address terminal 103.

The channel change information 1208 is a newly extended portion, and is information which shows changing channels by inter-terminal direct communication.

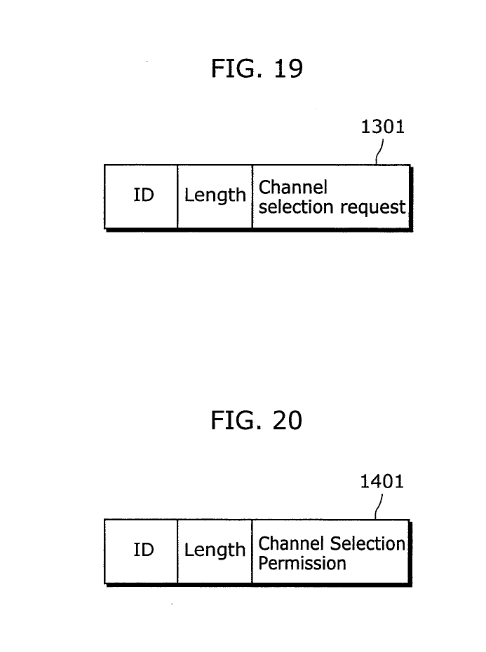

FIG. 19 is a diagram which shows an example of the format of the channel selection request IE included in channel change information 1208. The channel selection request IE shown in FIG. 19 includes a channel selection request 1301. Information and so on about change destination wireless channels is included in the channel selection request 1301. By superimposing the channel selection request IE in FIG. 19 on the DLS-Request frame, terminal 102 can notify the access point 101 and terminal 103 of information about the wireless channel used in inter-terminal direct communication.

Also, when changing channels on the access point 101 side is permitted, the access point 101 issues a notification that the channel change has been permitted by a channel selection permission IE which is included in the channel change information 1208 of the DLS-Response frame.

FIG. 20 is a diagram which shows an example of the format of the channel selection permission IE included. The channel selection permission IE shown in FIG. 20 includes a channel selection permission 1401. In the channel selection permission 1401, information is included which indicates whether or not the access point 101 permits performing inter-terminal direct communication by changing channels to another channel for the terminal.

It follows from the above that the terminal which performs inter-terminal direct communication detects that the channel is changed in order to perform inter-terminal direct communication since the access point 101 acquires channel change information from the DLS-Request frame, and the access point 101 can display in the Beacon the channel change information and so on necessary for the terminal which performs inter-terminal direct communication to change channels.

Here, the channel change notification method may be a method besides the method above which utilizes DLS, and may be a method which uses the Association procedure.

The Association procedure is the procedure in Step S101 in FIG. 11; the terminal notifies the access point of information held by the terminal itself, and the access point has the role of judging whether the terminal can be held inside the BSS of the access point itself. Accordingly, a contradiction will not be generated in the Association procedure even if the terminal issues a notification that the terminal itself will change wireless channels via inter-terminal direct communication during the procedure. For example, the terminal during the Association procedure can notify the access point that the wireless channel is to be changed for inter-terminal direct communication as shown below.

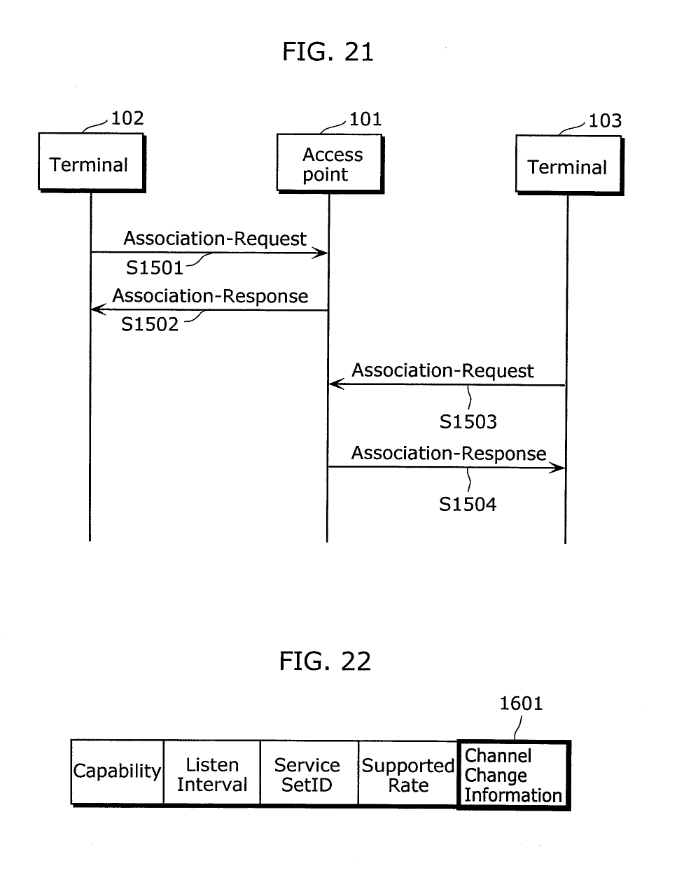

FIG. 21 is a diagram which shows a channel change notification process flow which uses the Association procedure. Terminal 102 and terminal 103, which perform inter-terminal direct communication, use an Association-Request IE and request that the access point 101 perform inter-terminal direct communication. Terminal 102 as shown in FIG. 21 transmits the Association-Request which includes channel change information to the access point 101 (S1501). The access point 101 transmits an Association-Response to terminal 102 which includes information indicating whether or not changing channels is permitted (S1502). In the same way, terminal 103 transmits the Association-Request included in the channel change information to the access point 101 (S1503). The access point 101 transmits an Association-Response, which includes information indicating whether changing channels is permitted or not permitted, to terminal 103 (S1503).

FIG. 22 is a diagram which shows the structure of an Association frame format used in the channel changing notification. The frame format shown in FIG. 22 includes the channel change information 1601 which is an extended portion. The channel change information 1601 displays information which expresses that the channel is changed via inter-terminal direct communication. The channel selection request IE shown in FIG. 19 or the channel selection permission IE shown in FIG. 20 are included in the channel change information 1601.

The access point 101 detects that the terminal which performs inter-terminal direct communication changes channels in order to perform inter-terminal direct communication by obtaining the channel change information 1601, judges whether the information can be held; when the information can be held, the access point 101 can display channel change information and so on in the Beacon, the channel change information and so on being needed by the terminal which performs inter-terminal direct communication to change channels.

Note that the channel change notification process shown in FIG. 21 may be performed with the timing of Step S103 through S105 after the authentication process (S101) in FIG. 11 and the authentication process (S101) may be performed simultaneously.

Next, a method is described in which the access point 101 notifies each terminal of channel change information acquired in the channel change notifications (S103 through S105) in FIG. 11.

The access point 101 overlaps the IE, which includes channel change information in the regularly transmitted Beacon, and terminal 102 and terminal 103, which receive Beacons, change channels. First, the signal generation unit 404 in the access point 101 generates a Beacon which includes the wireless channel information which is used in inter-terminal direct communication and is transmitted from terminal 102 in Step S103 of FIG. 11. The transmission unit 401 transmits the Beacon generated by the signal generation unit 404 to terminal 102, terminal 103 and terminal 104.

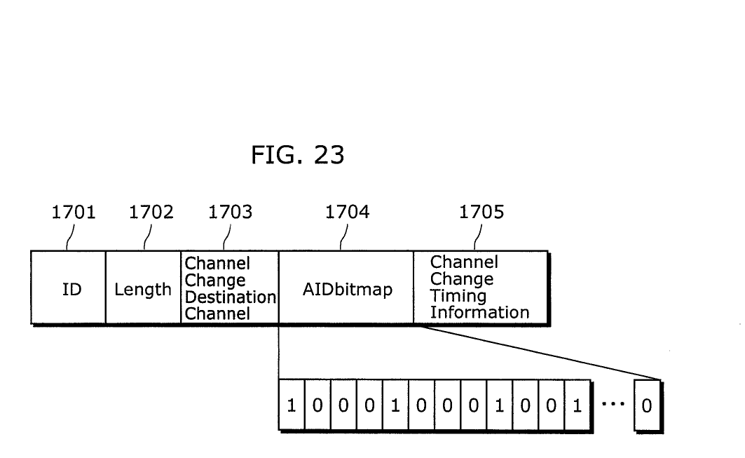

FIG. 23 is a diagram which shows an example of an IE structure which includes channel change information. The channel change information IE shown in FIG. 23 includes an ID 1701, a Length 1702, a channel change destination channel 1703, an AID bitmap for the channel changing wireless terminal 1704 and a channel change timing information 1705.

The ID 1701 is an identifier for identifying the type of channel change information IE and may use a value undefined in the IEEE802.11 specifications. The Length 1702 expresses length information for the channel change information IE.

The channel change destination channel 1703 indicates the channel change destination channel for performing inter-terminal direct communication.

The AID bitmap for the wireless terminal 1704 which changes channels is a bitmap which shows the AID of a terminal that changes channels, for example, when bit 1, bit 5, bit 9, bit 12 of the channel change wireless terminal AID are valid, four terminals with AID=1, AID=5, AID=9, AID=12 indicate that the wireless channels are changed in order to perform inter-terminal direct communication.

Information for synchronizing each of the terminals when the wireless terminal which performs inter-terminal direct communication changes wireless channels is shown in the channel change timing information 1705.

For example, the channel change timing information is information necessary for a channel change method using a timer, or a synchronization method, and the like, performed by exchanging signals between changing terminals when changing channels.

It follows from the above that the terminal which has received the Beacon can obtain the channel change timing information 1705 necessary for the channel change. Also, each terminal can judge whether or not the terminal must change channels using the terminal AID bitmap for the channel changing wireless terminal 1704. Also, when the channel must be changed, the wireless channel to be changed can be judged using the change destination channel 1703. Therefore, when inter-terminal direct communication is performed, each terminal can change channels based on the channel change information IE included in the received Beacon.

Note that in the above explanation, the data sending address terminal 102 determines the channel used in inter-terminal direct communication, however the data sending address terminal 102 may transmit only a data forwarding request to the data destination address terminal 103 through the access point 101, and the channel selection unit 407 in the access point 101 may determine the wireless channel used in inter-terminal direct communication.

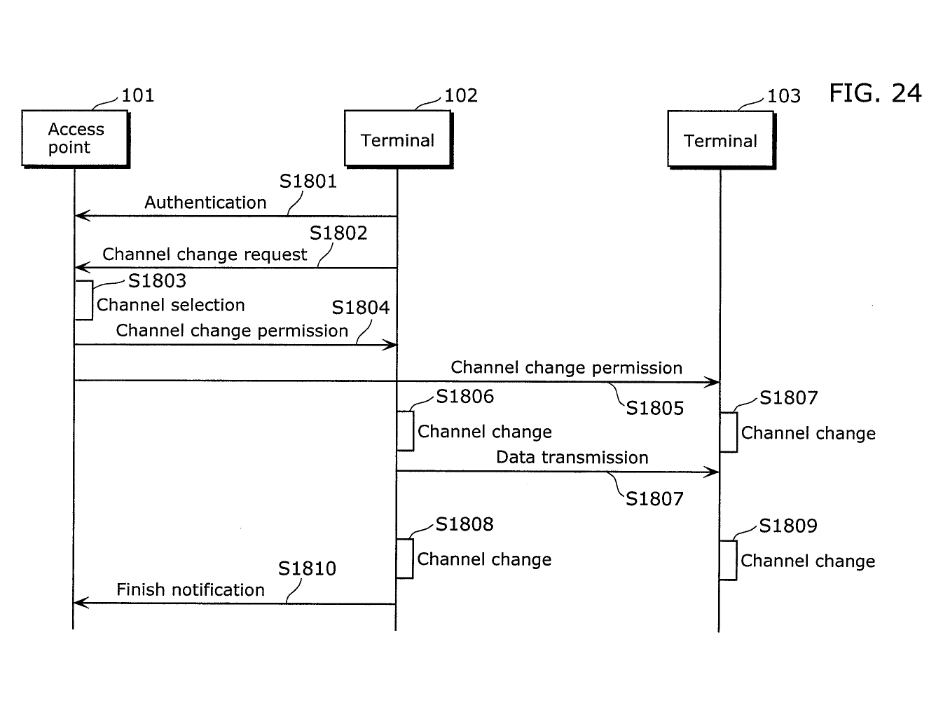

FIG. 24 is a diagram which shows a flow of inter-terminal direct communication processes when the access point 101 determines the wireless channel used in inter-terminal direct communication.

When the access point 101 selects a wireless channel to be used in inter-terminal direct communication, as shown in FIG. 24, the data sending address terminal 102 first performs an authentication process on the access point 101 and notifies the access point 101 of information and the like about the wireless channel supported by terminal 102 (S1801). Note that terminal 103 in FIG. 24 has already performed the authentication process on the access point 101.

Next, terminal 102 requests to perform inter-terminal direct communication with terminal 103 (S1802).

When the channel selection unit 407 in the access point 101 permits terminal 102 to change channels, the wireless channel used in inter-terminal direct communication between terminal 102 and 103 is selected (S1803). Due to the authentication processes performed by terminal 102 and terminal 103, the access point 101 holds information about wireless channels supported by terminal 102 and terminal 103 in the holding unit 406. The channel selection unit 407 determines wireless channels that are compatible with terminal 102 and terminal 103 using information about the wireless channels supported by each terminal held by the holding unit 406. Also, the access point 101 determines wireless channels which are available or have little traffic by performing the SCAN process or DFS as described above. Thus, the channel selection unit 407 in the access point 101 can select the wireless channel to which inter-terminal direct communication is to be allocated from wireless channels which are supported by terminal 102 and terminal 103 and are available. Note that the the SCAN process or DFS may be timed to be performed when the wireless channel selection process is performed (S1803); the regular estimation result and so on may be held in the holding unit 406, and the channel selection unit 407 may read out the estimation result and so on from the holding unit 406 during the wireless channel selection process (S1803) performed by the channel selection unit 407.

The access point 101 transmits the selected wireless channel information as well as permission for the channel change to terminal 102 and terminal 103 (S1804, S1805). For example, the access point 101 notifies terminal 102 and terminal 103 of the wireless channel information selected and permission for the channel change by transmitting the Beacon, which includes the channel change information. For example, the access point 101 transmits the Beacon, which includes the IE shown in FIG. 23, to terminal 102 and terminal 103.

In the same way as when terminal 102 selects the channel in FIG. 11, after notification of the channel change permission, terminal 102 and terminal 103 change channels to the designated wireless channel (S1806, S1807), terminal 102 transmits data to terminal 103 (S1807), terminal 102 and terminal 103 change channels to the wireless channel used by the access point 101 (S1808, S1809), and terminal 102 notifies the access point 101 that inter-terminal direct communication is finished (S1810).

Therefore, the access point 101 can select the wireless channel allocated for inter-terminal direct communication. By selecting the wireless channel allocated for inter-terminal direct communication, each terminal does not need to select the wireless channel used in inter-terminal direct communication. Thus, the structure of each terminal can be streamlined since each terminal need not be functional to select the wireless channel.

Next, the wireless channel changing process for terminal 102 and terminal 103 (Step S106 and S107 in FIG. 11) is explained below.

After terminal 102 and terminal 103 have received the channel change information IE described above and the channel change has been immediately performed, there is a possibility that the timing of the channel change for terminal 102 and terminal 103 will diverge due to differences in the process speed and so on of terminal 102 and terminal 103. For example, when terminal 102 changes the channel first, since terminal 103 is not on the channel change destination channel, it is possible that the terminal 102 misinterprets that an error has occurred, such as the power in terminal 103 dropping and that data transfer is interrupted. In order to avoid these problems, the channel change for terminal 102 and terminal 103 must be synchronized.

The two methods shown below are methods which synchronize terminal 102 and terminal 103 and change the channel.

To begin with, the first method is a method which uses a Beacon transmitted by the access point 101.

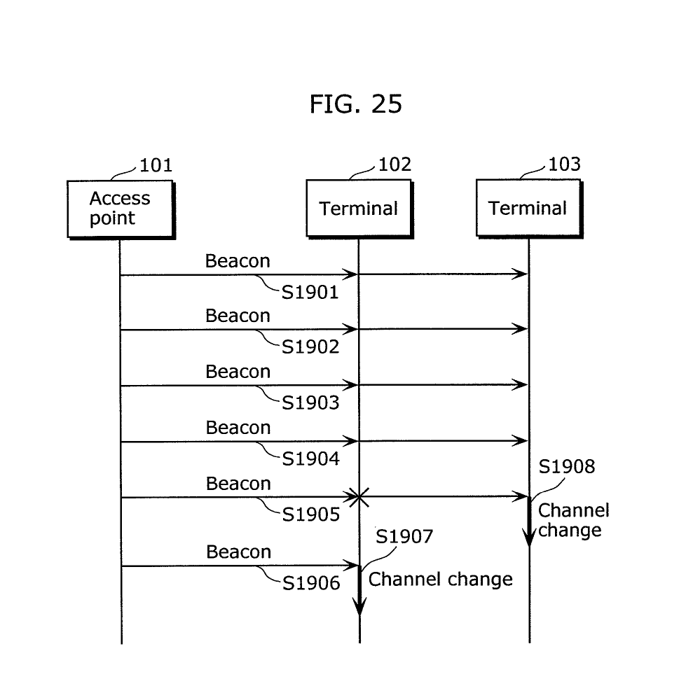

FIG. 25 is a diagram which shows a countdown method wireless channel changing process that uses Beacons. The wireless channels are changed after terminal 102 and terminal 103 have received the channel change information IE, and after a number of Beacons have been received, the number of beacons being designated by the channel change timing information 1705 included in the Beacon. In other words, after terminal 102 and terminal 103 have received the channel change information IE, the reception unit 302 counts the number of Beacons received. The channel switching unit 303 in terminal 102 and terminal 103 changes the wireless channel used by the terminal from the wireless channel used in inter-terminal direct communication to the wireless channel used by the access point 101, on a timing when the count value reaches the number of Beacons designated in the channel change timing information 1705, which is included in the Beacon. For example, when the terminal is designated to change channels after receiving five Beacons, as shown in FIG. 25, channel change is performed (S1908) when five Beacons are received (S1901 through S1905) and after terminal 103 determines that the channels are changed (S1908). Also, even when terminal 102 shown in FIG. 25 fails to obtain a Beacon (S1905), the wireless channels can be changed again when the next Beacon is received (S1906). Thus, even when terminal 102 and terminal 103 fail to receive a Beacon due to unfavorable communication conditions, the channels can be changed.

It follows from the above that the changing of the wireless channels in terminal 102 and terminal 103 can be synchronized. Also, by using a method that changes channels after receiving the Beacon several times, the channels can be changed even when the communication conditions are poor and terminal 102 and terminal 103 fail to receive the Beacon.

The second method, which synchronizes the changing of the wireless channels in terminal 102 and terminal 103, is a method that exchanges a synchronization signal for changing channels between terminals that perform inter-terminal direct communication.

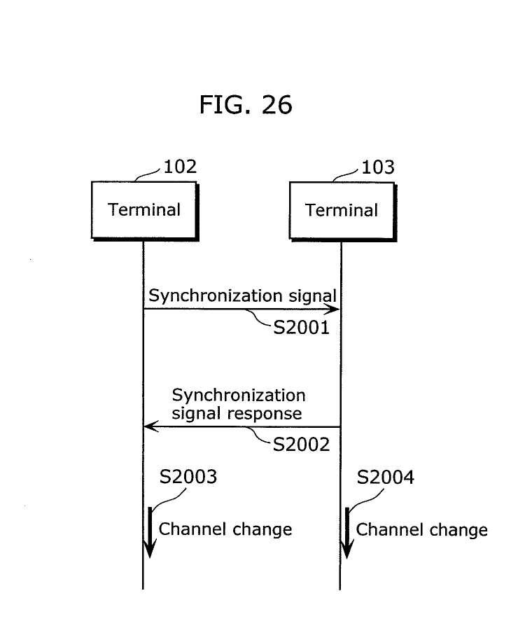

FIG. 26 is a diagram which shows a wireless channel changing process that exchanges a synchronization signal for changing channels between terminals which perform inter-terminal direct communication. As shown in FIG. 26, terminal 102 transmits the synchronization signal to terminal 103 when terminal 102 is ready to change the wireless channel (S2001). Terminal 103, which receives the synchronization signal, responds to terminal 102 with information about whether not terminal 103 is in a state where the channels can be changed and inter-terminal direct communication can be performed (S2002). When changing the wireless channel is permitted, the signal generation unit 304 in terminal 103 generates a response signal which indicates “available”, and transmits the response signal to terminal 102. Also, when the wireless channels are not ready to be changed, the signal generation unit 304 in terminal 103 generates the following two types of response signals and transmits these to terminal 102. The signal generation unit 304 in terminal 103 generates a response signal which indicates ‘extension’ when terminal 103 is not ready to change the channels and requests that changing the wireless channels be delayed. Or, when the wireless channel cannot be changed for some reason, a response signal indicating “unavailable” is generated.

Terminal 102 changes the wireless channels when the response signal indicating “available” is received (S2003). Also, terminal 103 changes the wireless channels when a response signal indicating “available” is transmitted (S2004). On the other hand, when terminal 102 receives a response signal which indicates “delay”, terminal 102 stands by until the response signal which indicates “available” is received from terminal 103. Terminal 103 transmits the response signal which indicates “available” to terminal 102 when terminal 103 has finished preparations for changing the wireless channels and after transmitting the response signal which indicates “delay”. Also, when terminal 102 receives “unavailable”, terminal 102 judges that it cannot perform inter-terminal direct transmission, and terminal 102 interrupts the procedure for changing the wireless channel.

It follows from the above that the wireless channel change can be synchronized between terminals which perform inter-terminal direct communication. Note that in the above explanation, a synchronization signal is transmitted from the data sending address, terminal 102, however the synchronization signal may be transmitted from the data destination address, terminal 103.

Next, a case in which a terminal that performs inter-terminal direct communication uses Hybrid Coordination Function Controlled Channel Access (HCCA) is explained.

When inter-terminal direct communication is started, the terminal which uses HCCA must receive a QoS-CF-Poll frame from the access point 101, which indicates permission to start communication. It is acknowledged that the terminal which received the QoS-CF-Poll frame is permitted to perform communication, and can communicate within a pre-allocated time period. As in the wireless communication system according to the present embodiment, even when inter-terminal direct communication is performed using a different wireless channel from the wireless channel used by the access point 101, similar to a conventional wireless communication system which uses HCCA, the same kind of control can be performed as in a conventional wireless communication system which uses HCCA using a method that starts communication after receiving the QoS-CF-Poll frame. In other words, the wireless communication system according to the present invention can be realized without performing major modifications to the control method from the conventional wireless communication system.

One method of transmitting the QoS-CF-Poll frame from the access point 101 in HCCA is a method of allocating time for performing communication between terminal 102 and 103, with which the access point 101 performs inter-terminal direct communication using polling processing.

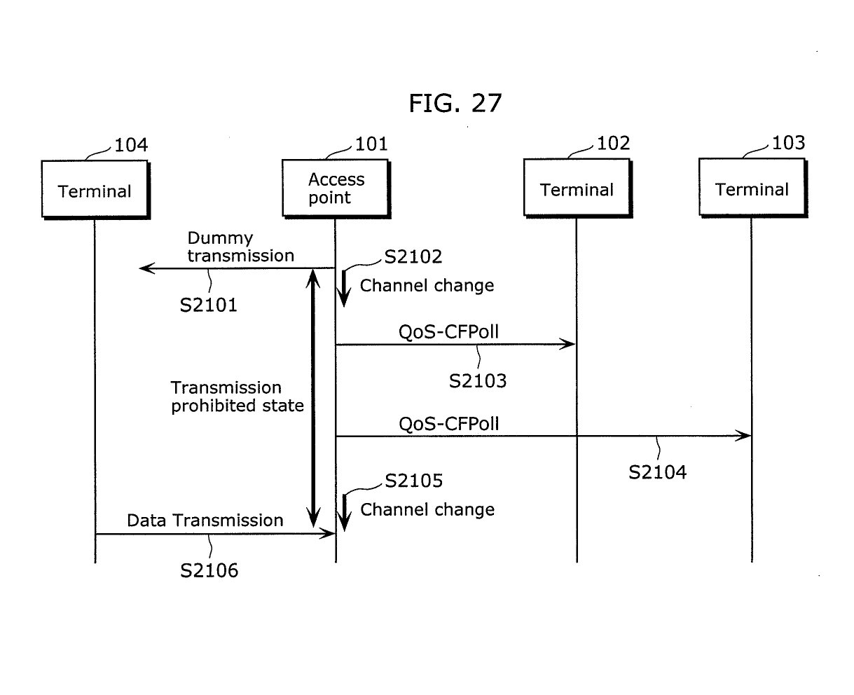

FIG. 27 is a diagram which shows a process of transmitting the QoS-CF-Poll frame from the access point 101.

In order for the access point 101 to transfer the QoS-CF-Poll frame to terminal 102 and terminal 103, the access point 101 must change channels to the wireless channel to which terminal 102 and terminal 103 have changed and transmit the QoS-CF-Poll frame. While the access point 101 changes to the wireless channel used in inter-terminal direct communication, wireless communication cannot be performed on the wireless channel which the access point 101 has used. Thus, the access point 101 changes the wireless channel and transmits the QoS-CF-Poll frame, and must prohibit wireless communication from another terminal while the wireless channel returns again to the previous wireless channel. Network Allocation Vector (NAV) is a method used for this purpose.

As shown in FIG. 27, the access point 101 prepares to change channels before the timing at which the access point 101 transmits the QoS-CF-Poll to terminal 102 and terminal 103. First, the signal generation unit 404 in the access point 101 generates a signal which includes NAV information, which is a signal to which information is attached which indicates that transmitting data from terminal 104, which performs wireless communication on the wireless channel used by the access point 101, is prohibited. The transmission unit 401 in the access point 101 transmits a signal which includes NAV information generated by the signal generation unit 404 (S2101). In the Duration ID field which displays NAV information, the time period is set in which the access point 101 changes channels, transmits the QoS-CF-Poll frame and changes the wireless channel again. Thus, since terminal 104 cannot perform wireless transmission within the time period shown in the Duration ID field, no communication occurs from terminal 104 to the access point 101.

Thus, since no communication occurs while the access point 101 changes the channels, lost packets will not be generated.

After the transmission unit 401 transmits the signal which includes NAV information, the channel switching unit 403 in the access point 101 switches the wireless channel used by the access point 101 to the wireless channel on which terminal 102 and terminal 103 perform inter-terminal direct communication (S2102). The access point 101 transmits the QoS-CF-Poll frame to terminal 102 and terminal 103 (S2103, S2104), the QoS-CF-Poll frame being a signal which permits inter-terminal direct communication to start using the wireless channel on which terminal 102 and terminal 103 perform inter-terminal wireless communication. Terminal 102 and terminal 103, which have received the QoS-CF-Poll frame, start inter-terminal direct communication. On the other hand, the access point 101 which has transmitted the QoS-CF-Poll frame, changes channels to the original channel (S2105).

It follows from the above that the access point 101 can transmit the QoS-CF-Poll frame to terminal 102 and terminal 103, which perform inter-terminal direct communication. Thus, terminal 102 and terminal 103 can start communication after receiving the QoS-CF-Poll frame, in the same way as the conventional wireless communication system using HCCA. Thus, the wireless communication system according to the present embodiment can be realized without performing major modifications to the control method for the conventional wireless communication system.

Note that when HCCA is not used, data communication may be started after terminal 102 and terminal 103 have changed channels.

Next, the operations in a state in which terminal 102 and terminal 103 perform inter-terminal direct communication are explained (Step S108 in FIG. 11).

First, the Beacon receiving method for the terminal that performs inter-terminal direct communication is explained below.

The terminal connected by wireless link with the access point 101 receives the Beacon transmitted regularly from the access point 101 for synchronizing with the access point 101, and the terminal synchronizes with the access point 101.

In order to synchronize the terminal which performs inter-terminal direct communication and the access point 101, the Beacon must be received. In order to receive the Beacon, the terminal which performs inter-terminal direct communication can realize synchronization with the access point 101 by either receiving the Beacon after returning to the wireless channel on which the access point 101 transmits the Beacon, or the access point 101 transmits the Beacon after changing to the wireless channel on which the terminal performs inter-terminal direct communication.

First, a method for transmitting the Beacon by the access point 101 changing channels to the wireless channel on which the terminal performs inter-terminal direct communication is explained.

The access point 101 transmits the Beacon at a frequency set beforehand. The signal generation unit 404 of the access point 101 does not have to receive a reception notice (ACK) on the receiving side since the Beacon destination address is set to broadcast. Thus, the access point 101 may only transmit the Beacon.

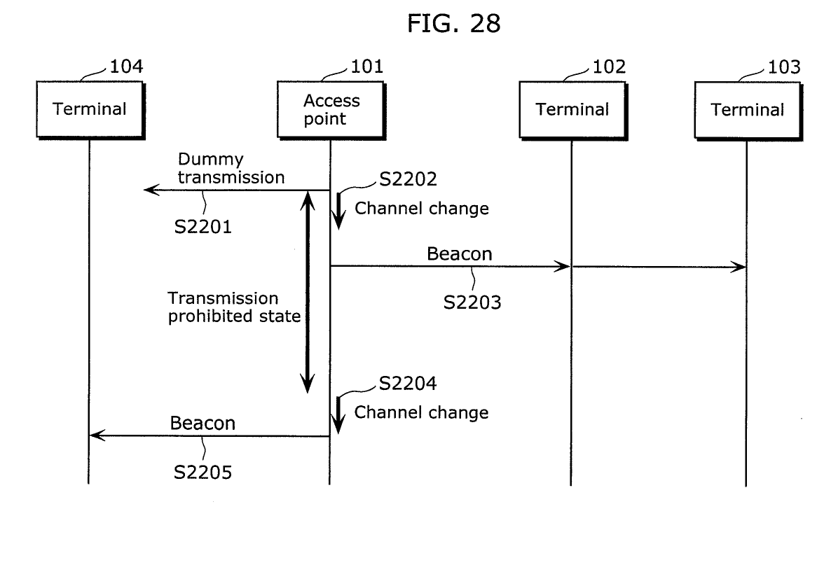

FIG. 28 is a diagram which shows an operation in which the access point 101 periodically changes wireless channels and transmits the Beacon. When the count value of the timer 409 reaches a pre-set value, the wireless channel used by the access point 101 is set to a communication-prohibited state using NAV (S2201). Subsequently, the access point 101 changes channels to the wireless channel on which inter-terminal direct communication is performed (S2202). In other words, the channel switching unit 403 in the access point 101 switches the wireless channel used in wireless communication from the wireless channel used in communication between the access point 101 and the terminal to the wireless channel used in inter-terminal direct communication. The access point 101 which has changed channels transmits the Beacon to terminal 102 and terminal 103, which are on the destination channel (S2203). The access point 101 changes channels to the original wireless channel after the Beacon is transmitted (S2204). After changing channels, the Beacon is transmitted on the wireless channel used by the access point (S2205). The Beacon transmitted in Step S2205 includes necessary information in the wireless channel used by the access point.

According to the method above, the access point 101 can transmit the Beacon to terminal 102 and terminal 103, which perform inter-terminal direct communication, by changing the wireless channel. Thus, terminal 102 and terminal 103, which perform inter-terminal direct communication, can synchronize with the access point 101 using the Beacon received.

Next, a method is shown in which the terminals which perform inter-terminal direct communication return to the wireless channel on which the access point 101 transmits the Beacon and receive the Beacon.

The access point 101 transmits the Beacon which includes Beacon interval information, which is information about the transmission period of the Beacon. Terminal 102 receives the Beacon, which includes Beacon interval information, before changing channels to the wireless channel used in inter-terminal direct communication, and ascertains the transmission period of the Beacon transmitted by the access point 101.

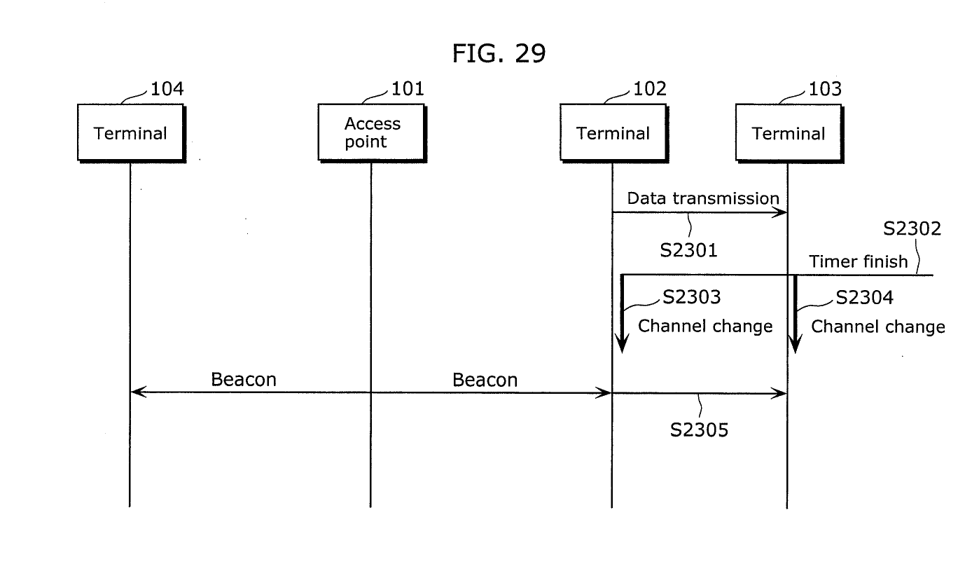

FIG. 29 is a diagram which shows a process in which the terminal which performs inter-terminal direct communication changes wireless channels and receives the Beacon. The channel switching unit 303 in terminal 102 and terminal 103 changes the wireless channel used from the wireless channel used in inter-terminal direct communication to the wireless channel used by the access point 101. More specifically, terminal 102 and terminal 103 count a time period in which the access point 101 transmits the Beacon, using the timer 309. Terminal 102 and terminal 103 change channels to the wireless channel used by the access point 101 (S2303, S2304) when the count value of the timer 309 reaches a value based on the Beacon interval information (S2302). The reception units 302 in terminal 102 and terminal 103, which have changed channels, receive the Beacon transmitted by the access point 101 (S2305). Terminal 102 and terminal 103 change channels to the wireless channel used in inter-terminal direct transmission after receiving the Beacon and re-open inter-terminal direct communication.

Here, the access point 101 in FIG. 28 does not need to perform the process using NAV (S2201) when the access point 101 changes wireless channels. Since terminals 102 and 103, which perform inter-terminal direct communication, have changed channels to the wireless channel used by the access point 101 when the Beacon is received, wireless communication does not occur in the channel in which inter-terminal direct communication is performed.

It follows from the above that after changing wireless channels, terminal 102 and terminal 103, which perform inter-terminal direct communication, can receive the Beacon transmitted by the access point 110. Also, compared to when the access point 101 changes wireless channels and transmits the Beacon, the process can be simplified since the original channel does not need to be set to a communication-prohibited state using NAV. Further, when the access point 101 changes wireless channels and transmits the Beacon, the access point 101 must transmit the Beacon on the wireless channel used by the access point 101 as well as the wireless channel used in inter-terminal direct communication, however when terminal 102 and terminal 103, which perform inter-terminal direct communication, change channels and receive the Beacon, the Beacon may be sent once thereby reducing processing.

Next, a method for transmitting data from the access point 101 to the terminals which perform inter-terminal direct communication is explained.

When packet communication is regularly performed from the access point 101, the terminal which performs inter-terminal direct communication must communicate with the access point 101. For example, there are cases where communication must be performed with a master device (the access point) such as when a content stream is distributed, or when communicating using a telephone slave device (between terminals).

In stream distribution and so on, transmission data load and timing can be unilaterally determined. In other words, the access point can communicate with the terminals that perform inter-terminal direct communication by scheduling the timing for performing communication beforehand.

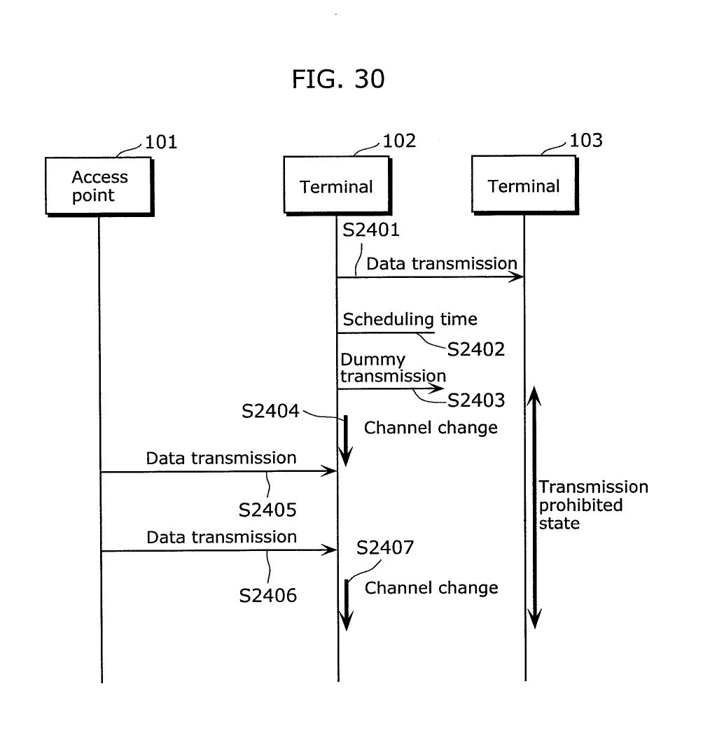

FIG. 30 is a figure which shows the process when terminal 102, which performs inter-terminal direct communication, communicates with the access point 101. The signal generation unit 404 in the access point 101 generates the Beacon which includes a Beacon information IE that includes information about timing for transmitting data to terminal 102 from the access point 101. The access point 101 transmits the Beacon to terminal 102 and terminal 103 using the method described above (the method in which the access point 101 changes channels and transmits the Beacon, or the method in which terminal 102 and terminal 103 change channels and receive the Beacon). Terminal 102 and terminal 103, which perform inter-terminal direct communication, can ascertain the timing for distributing from the access point 101 to terminal 102 based on the Beacon information IE included in the Beacon received.

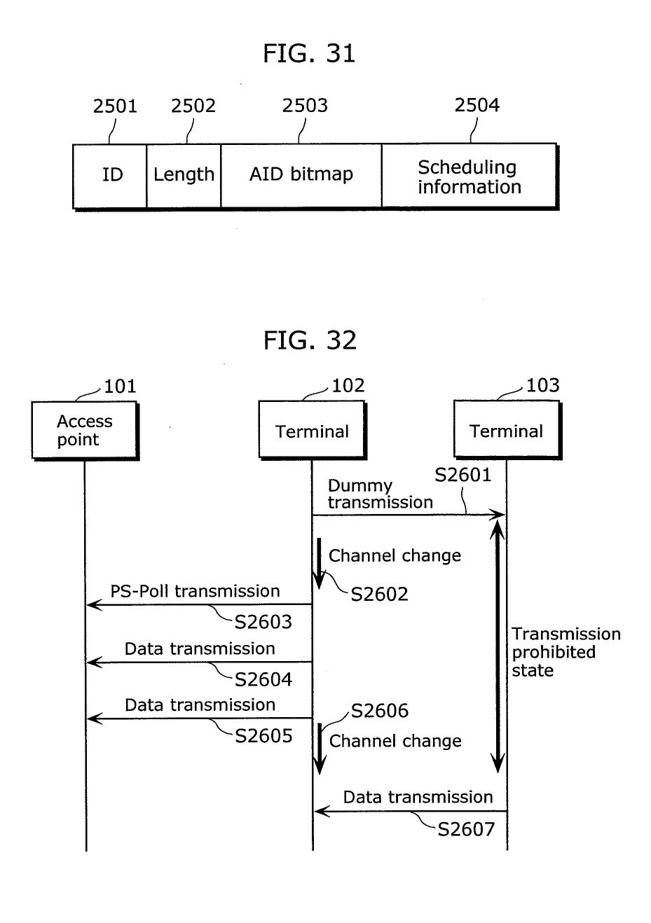

FIG. 31 is a diagram which shows the structure of the Beacon information IE. As shown in FIG. 31, the Beacon information IE includes an ID2501, a Length 2502, an AID bitmap 2503 for the terminal which communicates with the access point 101, and the scheduling information 2504.

The ID2501 is an identifier for identifying the type of IE, and may use a value undefined in IEEE802.11. The Length 2502 indicates the length information of the IE.

The scheduling information 2504 is timing information for the access point 101 to communicate with terminal 102. Terminal 102 can receive data from the access point 101 by changing channels within a predetermined time period based on the scheduling information 2504. For example, the scheduling information 2504 is information which indicates that data is transmitted is transmitted from the access point 101 to terminal 102, 10 ms after the Beacon which includes the scheduling information 2504.

The channel switching unit 303 in terminal 102 switches the wireless channel used by the terminal from the wireless channel used in inter-terminal direct communication to the wireless channel used by the access point 101 by a timing based on a scheduling information 2504. In other words, after terminal 102 receives the Beacon, a time period in which data is transmitted from the access point 101, as shown in the scheduling information 2504, is counted by the timer 309.

When the scheduled time period is reached (S2402), terminal 102 transmits a dummy to terminal 103 (S2403) in order to set the wireless channel that terminal 102 uses to the communication prohibited state. The time period in which terminal 102 changes channels, receives data from the access point 101 and changes channels again is set in the Duration ID field, which shows NAV information included in the dummy transmission frame. Thus communication does not occur between terminal 103 and terminal 102 since terminal 103 cannot perform wireless communication within the time period set in the Duration ID field. After the dummy is transmitted, terminal 102 changes channels to the wireless channel utilized by the access point 101 (S2404).

On the other hand, the transmission unit 401 in the access point 101 transmits data to terminal 102 on the wireless channel used by the access point 101 in communication when the timing notified by the scheduling information 2504 included in the Beacon is reached (S2405, S2406). The access point 101 in FIG. 30 transmits data twice to terminal 102. The reception unit 302 in terminal 102, which has changed channels to the wireless channel utilized by the access point 101, receives the data transmitted by the access point 101. After receiving the data, terminal 102 changes channels to the wireless channel used for performing inter-terminal direct communication with terminal 103 (S2407), and re-opens inter-terminal direct communication with terminal 103.

It follows from the above that terminal 102 can transmit data from the access point 101 to the terminal that performs inter-terminal direct communication on a different wireless channel from the wireless channel used by the access point 101.

Next, a method for transmitting data from the terminal which performs inter-terminal direct communication to the access point is explained.

When transmitting from terminal 102 which performs inter-terminal direct communication to the access point 101, terminal 102 must notify the access point 101 that there is data is to be transmitted.

FIG. 32 is a diagram which shows the process of transmitting data from terminal 102, which performs inter-terminal direct communication, to the access point 101.

According to IEEE802.11 specifications, when there is data to be transmitted by terminal 102, which is in a power management state, to the access point 101, terminal 102 which is in the power management state transmits the PS-Poll frame to the access point 101, notifying the access point 101 of data which must be transmitted. Using this arrangement, terminal 102, which performs inter-terminal direct communication, can notify the access point 101 of data which must be transmitted by using the PS-Poll frame.

As shown in FIG. 32, terminal 102 which performs inter-terminal direct communication transmits a dummy in order to put the wireless channel used in inter-terminal direct communication with terminal 103 into the communication prohibited state (S2601). A time period in which terminal 102 changes channels and transmits data to the access point 101 and changes channels again is set in the Duration ID field, which shows NAV information included in the frame in which the dummy is transmitted. Thus communication to terminal 102 does not occur since terminal 103 cannot perform wireless communication within the time period set in the Duration ID field. After the dummy is transmitted, terminal 102 changes to the wireless channel utilized by the access point 101 (S2602). The transmission unit 301 in terminal 102 transmits the PS-Poll frame, which is a signal notifying the access point 101 that communication is to be performed, using the wireless channel utilized by the access point 101 (S2603). The access point 101, which receives the PS-Poll frame from terminal 102, acknowledges that there is data to be transmitted from terminal 102. The transmission unit 301 in terminal 102 transmits data to the access point 101 after transmitting the PS-Poll frame (S2604 and S2605). In FIG. 32, data is transmitted twice from terminal 102 to the access point 101. After transmitting the data, terminal 102 changes channels to the wireless channel used for performing inter-terminal direct communication with terminal 103 (S2606).

It follows from the above that terminal 102 which performs inter-terminal direct communication can transmit data to the access point 101 by changing wireless channels.

Next, a method is shown in Step S2604 and S2605 of FIG. 32 in which, after data is transmitted, communication with the access point 101 is finished and terminal 102 returns to the wireless channel used for performing inter-terminal direct communication. Using one of three methods shown below, terminal 102 judges a timing for finishing communication with the access point 102.

The first method is a method which finishes communication with the access point 101 when data that must be transmitted from terminal 102 to the access point 101 has cleared, and returns to the wireless channel used in inter-terminal direct communication.

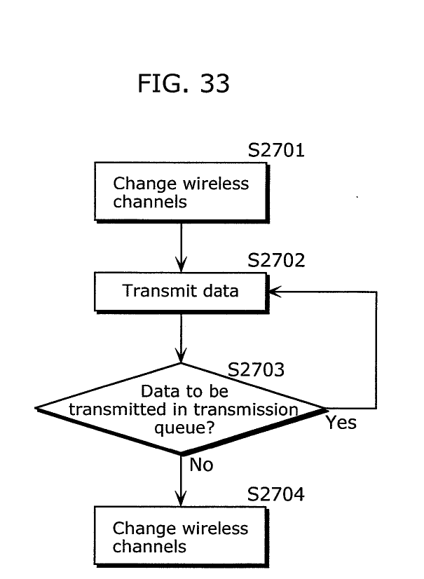

FIG. 33 is a flowchart that shows the first method. As shown in FIG. 33, terminal 102 changes channels to the wireless channel used by the access point 101 (S2701). Next, terminal 102 transmits data to the access point 101 (S2702). Terminal 102 judges whether or not there is data to be transmitted to the access point 101 directly after transmitting the data (S2703). More specifically, terminal 102 judges whether or not the data to be transmitted is queued in a queue corresponding to the transmission queue. When there is no queued data (No in S2703), terminal 102 finishes data transmission to the access point 101 and changes to the wireless channel used for performing inter-terminal direct communication (S2704). On the other hand, when there is data queuing in Step S2703 (Yes in S2703), terminal 102 immediately transmits data to the access point 101 (S2702), and afterwards immediately judges whether or not there is data to be transmitted (S2703). Terminal 102 repeats the processes in Step S2702 and S2703 until data to be transmitted to the access point 101 is cleared (until No in S2703).

It follows from the above that terminal 102 repeats transmission until the data to be transmitted to the access point 101 is cleared. In the first method, terminal 102 changes the channel and transmits data to the access point 101 within only the period necessary for data transmission. Thus, when the amount of data to be transmitted is low, such as a single data transmission, the first method is effective since the first method can immediately start communication with terminal 103 after transmitting data.

The second method is a method in which the time for transmitting data to the access point 101 is set, and terminal 102 returns to the wireless channel that performs inter-terminal direct communication when the predetermined time period is reached.

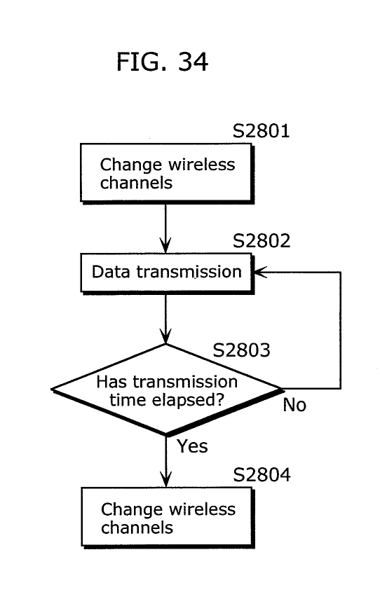

FIG. 34 is a flowchart of the second method. As shown in FIG. 34, terminal 102 changes channels to the wireless channel used by the access point 101 (S2801). Next, terminal 102 transmits data to the access point 101 (S2802). Terminal 102 judges whether or not the set time period has elapsed (S2803). Here, the set time period is for example a number of milliseconds for transmitting the audio data, and is several ten milliseconds in the transmission for video data. When the set time period has not elapsed (No in S2803), terminal 102 immediately transmits data (S2802). When the set time period has elapsed (Yes in S2803), terminal 102 finishes data transmission to the access point 101 and changes channels to the wireless channel used for performing inter-terminal direct communication (S2804).

Therefore, terminal 102 transmits data to the access point 101 within the set time period and finishes data transmission when the set time period is reached. Thus the second method finishes transmission before transmitting all of the data when the data load to be transmitted to the access point 101 is great. When the data load to be transferred to the access point 101 is great, transmission is finished before all of the data is transmitted. When the data load to be transferred to the access point 101 is great, the time period required for transmitting data to the access point 101 also increases; in the meantime, terminal 102 cannot communicate with terminal 103. Thus, the throughput between terminal 102 and terminal 103 drops in inter-terminal direct communication. In the second method, drops in the throughput between terminal 102 and terminal 103 in inter-terminal direct communication can be reduced since terminal 102 finishes communication with the access point 101 when the set time elapses, and re-opens inter-terminal direct communication with terminal 103.

The third method is a method in which an amount of transmissions to the access point 101 is set and when that amount of transmissions is reached, the terminal returns to the wireless channel that performs inter-terminal direct communication.

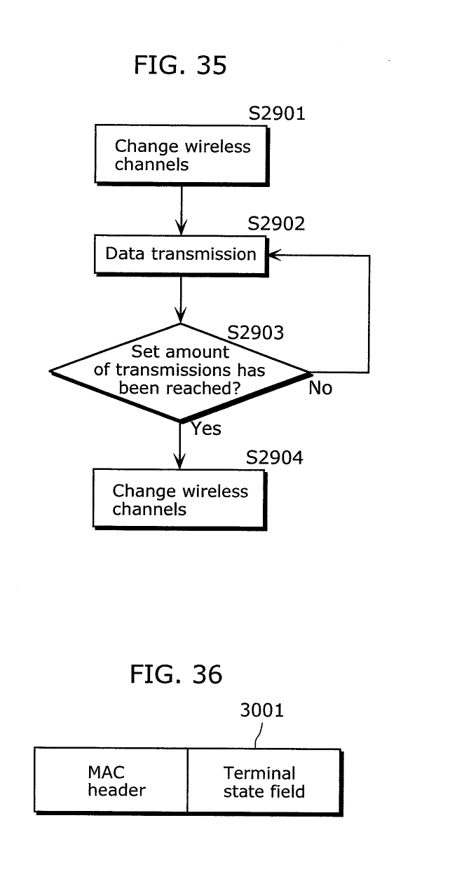

FIG. 35 is a flowchart of the third method. As shown in FIG. 35, terminal 102 changes channels to the wireless channel used by the access point 101 (S2901). Next, terminal 102 transmits data to the access point 101 (S2902). Terminal 102 judges whether or not transmission of the set amount of packets has occurred (S2903). Here, the set amount of packets is for example several packets in audio data transmission, and several ten packets in video data transmission. When the set amount of transmissions has not occurred (No in S2903), terminal 102 therefore transmits data (S2902). When the set amount of transmissions has been performed (Yes in S2903), terminal 102 finishes data transmission to the access point 101 and changes to the wireless channel used for performing inter-terminal direct communication (S2904).

It follows from the above that terminal 102 performs the set amount of data transmissions to the access point 101 and finishes data transmission. Thus the third method finishes transmitting before transmitting all of the data when the data load to be transmitted to the access point 101 is great. When the data load to be transferred to the access point 101 is great, the time period required for transmitting data to the access point 101 also increases and in the meantime, terminal 102 cannot communicate with terminal 103. Thus, the throughput between terminal 102 and terminal 103 in inter-terminal direct communication drops. In the third method, since terminal 102 finishes communicating with the access point 101 when the set time elapses, and re-opens inter-terminal direct communication with terminal 103, drops in the throughput between terminal 102 and terminal 103 in inter-terminal direct communication can be reduced.

Note that terminal 102 which transmits data to the access point 101 may judge to finish data transmission using one of the above described methods one through three, and may use the methods one through three in parallel. For example, when terminal 102 uses the first and second method in parallel, the predetermined time period has elapsed given that the data to be transmitted has cleared before the predetermined time period has elapsed, communication with the access point 101 may be finished.

Also, in FIG. 32, data is transmitted from terminal 102 to the access point 101 using the wireless channel used by the access point 101, however data may be transmitted from terminal 102 to the access point 101 using the wireless channel utilized in inter-terminal direct communication between terminal 102 and terminal 103. In other words, the access point 101 may receive data by changing channels to the wireless channel used in inter-terminal direct communication.

When the access point 101 changes wireless channels, the access point 101 can judge whether or not the terminal that performs data transmission is a terminal that performs inter-terminal direct communication and whether or not the channel must be changed, by using an extended PS-Poll frame.

FIG. 36 is a diagram which shows the structure of an extended PS-Poll frame. The PS-Poll frame shown in FIG. 36 includes the terminal state field 3001 which is a newly extended field.

The terminal state field 3001 indicates whether the terminal is in a power saving state (a state in which the terminal does not communicate) or in an inter-terminal direct communication state. When the access point 101 which received the PS-Poll frame has judged that the terminal which transmits data is in a power saving state according to the terminal state field 3001, the data is received from the terminal, without changing channels, using a process similar to the conventional processes. When the access point 101 judges that the terminal which transmits data is the terminal which performs inter-terminal direct communication according to the terminal state field 3001, the access point 101 changes channels to the wireless channel used in inter-terminal direct communication and transmits data.

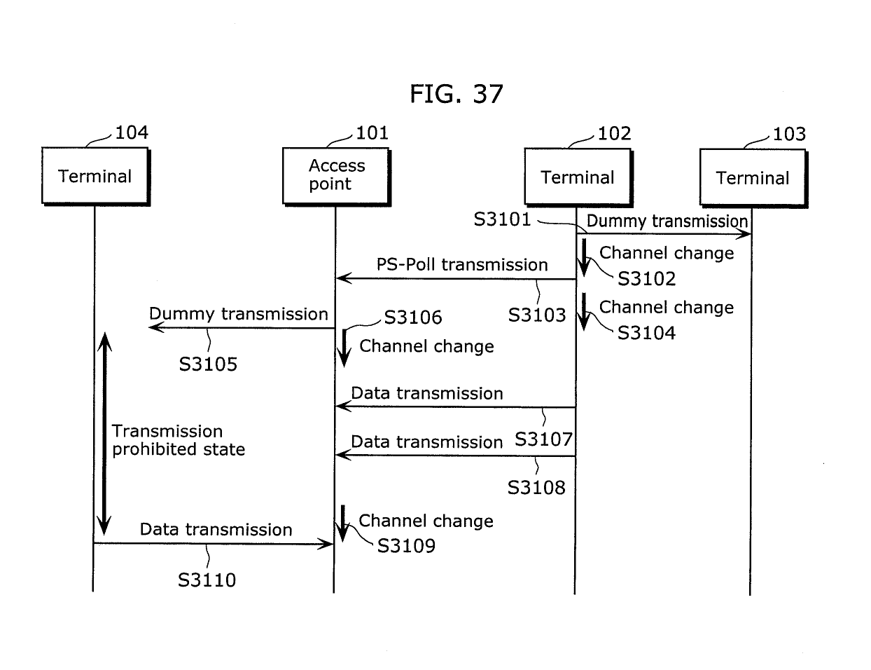

FIG. 37 is a diagram which shows functions when the access point 101 changes wireless channels and receives data from terminal 102.

In FIG. 37, terminal 102 transmits the dummy to terminal 103 (S3101), changes the wireless channel used by the access point 101 (S3102) and transmits the PS-Poll frame to the access point 101 (S3103), in the same way as steps S2601 through S2603 shown in FIG. 32. Here the terminal state field 3001 in the PS-Poll frame transmitted by terminal 102 in Step S3103 shows that the terminal which transmits the PS-Poll frame is a terminal that performs inter-terminal direct communication. The access point 101 receives the PS-Poll frame from terminal 102 and acknowledges that there is data to be transmitted from terminal 102. Also, the access point 101 acknowledges that there is data to be transmitted from the terminal which performs inter-terminal direct communication, according to the terminal state field 3001 in the PS-Poll frame.

Terminal 102, which transmits the PS-Poll frame, changes channels to the wireless channel used in inter-terminal direct communication (S3104).

After receiving the PS-Poll frame, the access point 101 transmits the dummy to terminal 104 in order to set the wireless channel utilized by the access point 101 to a communication-prohibited state. A time period for changing channels again is set in the Duration ID field, which shows NAV information and is included in the dummy transmission frame, by terminal 101 changing channels and receiving data from terminal 102. Because of this, communication from terminal 104 to the access point 101 does not occur since terminal 104 cannot perform wireless communication within the time period set in the Duration ID field.

After the dummy is transmitted, the access point 101 changes channels to the wireless channel used by terminal 102 and terminal 103 in inter-terminal direct communication (S3106).

Terminal 102 transmits data to the access point 101 after changing wireless channels (S3107 and S3108). In FIG. 37, terminal 102 transmits data twice to the access point 101. When the access point 101 finishes transmitting data from terminal 102, the access point 101 changes channels to the original wireless channel (S3109).

It follows from the above that since the access point 101 changes channels, data can be transmitted from terminal 102 to the access point 101. Also, compared to when data is transmitted on the wireless channel used by the access point 101 in FIG. 32, the period in which terminal 102 changes to the wireless channel used by the access point 101 decreases. Therefore, even while terminal 102 transmits data to the access point 101, terminal 102 can respond to access from terminal 103.

Next, a process in which the terminal finish wireless communication after transmitting data (the process after Step S108 in FIG. 11) is explained.

The access point 101 cannot ascertain whether or not a terminal performs inter-terminal direct communication as long as the access point 101 is not notified from the terminal that the terminal performs inter-terminal direct communication. In other words, when the terminal which performs inter-terminal direct communication has already stopped communication and cancelled the wireless link with the access point 101, and even when the access point changes channels to the wireless channel on which inter-terminal direct communication is performed in order to transmit the Beacon, sending the Beacon has no effect and only wastes a resource such as the frequency band. Thus, by performing a process such as the following, wasteful processes for the access point 101 will not be generated.

When the wireless link with the access point is cancelled because a terminal in the conventional wireless communication system stops wireless communication, and so on, the terminal notifies the access point by transmitting a Deauthentication frame to the access point. The access point, which has received the Deauthentication frame, detects that the wireless link with the terminal which has transmitted the Deauthentication frame has been cancelled and opens resource information and so on for the terminal, the resource information and so on being managed by the access point.

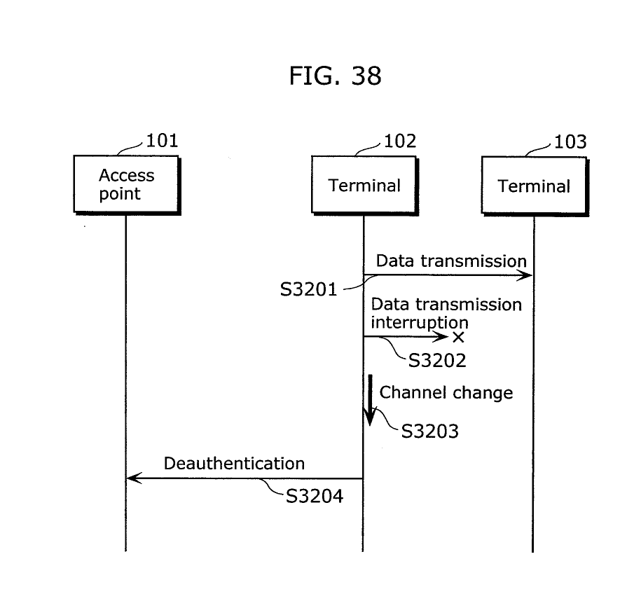

The above method is a conventional Deauthentication procedure, however this method is also used by a terminal which performs inter-terminal direct communication using a different wireless channel from the wireless channel used by the access point 101. FIG. 38 is a diagram which shows a process of the terminal, which performs inter-terminal direct communication, stopping inter-terminal direct communication. Terminal 102, which performs inter-terminal direct communication as shown in FIG. 38, finishes inter-terminal direct communication with terminal 103 (S3202). Inter-terminal direct communication is finished for example when data transmission is finished and communication between terminal 102 and terminal 103 is cancelled, and when communication with terminal 103 cannot be achieved due to an error (the power source drops, communication conditions deteriorate, and so on). Next, terminal 102 changes channels to the wireless channel used by the access point 101 (S3203). Terminal 102, which changes channels, transmits the Deauthentication frame, which notifies the access point 101 that inter-terminal direct communication will finish (S3204). The access point 101, which has received the Deauthentication frame, ascertains that terminal 102 has finished inter-terminal direct communication. The access point 101 opens the resource information and so on of terminal 102, which performs inter-terminal direct communication, changes to the wireless channel on which the access point 101 performs inter-terminal direct communication and after transmitting the beacon, stops the Beacon transmission on the wireless channel used for inter-terminal direct communication. Also, terminal 102, which finishes inter-terminal direct communication, enters a waiting state until the next communication is started. Note that terminal 102 does not only enter the waiting state after finishing inter-terminal direct communication. When terminal 102 cancels the wireless link, terminal 102 can also notify the access point 101 to cancel the wireless link by transmitting the Deauthentication frame to the access point 101 using similar processes. Thus, the access point 101 can ascertain that terminal 102 has canceled the wireless link.

Therefore terminal 102 can notify the access point 101 that inter-terminal direct communication has finished. Also, terminal 102 can notify the access point 101 that the wireless link is cancelled.

Note that in FIG. 38, terminal 102 transmits the Deauthentication frame to the access point 101 only, but terminal 102 may transmit the Deauthentication frame to terminal 103 as well.

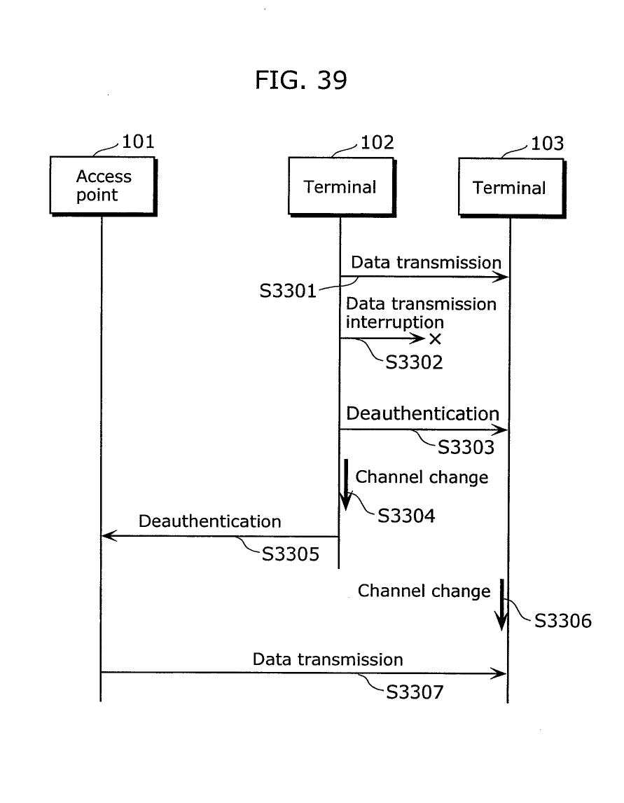

FIG. 39 is a diagram which shows the process by which the terminal which performs inter-terminal direct communication finishes communication. When terminal 102, which performs inter-terminal direct communication, cancels inter-terminal wireless communication or cancels the wireless link, terminal 102 transmits the Deauthentication frame to terminal 103, which notifies terminal 103 that inter-terminal direct communication is finished (S3303). Terminal 103 which receives the Deauthentication frame detects that inter-terminal direct communication has finished since terminal 102, which performs inter-terminal direct communication, has cancelled the wireless link and so on, using the source address inside the MAC header. Terminal 102, which has transmitted the Deauthentication frame, changes to the wireless channel on which the access point 101 communicates (S3304) and transmits the Deauthentication frame to the access point 101 (S3305). The access point 101, which has received the Deauthentication frame, acknowledges that terminal 102 has finished inter-terminal direct communication.

On the other hand, terminal 103 which has received the Deauthentication frame transmitted from terminal 102 in Step S3303 changes channels to the wireless channel used by the access point 101 (S3306) when terminal 103 does not need to remain at the wireless channel changed used to perform inter-terminal direct communication (when inter-terminal direct communication is performed with only terminal 102).

It follows from the above that even when the wireless link for one of the terminals which performs inter-terminal direct communication is cancelled, the terminal may be set to a state from which it can communicate with the access point by changing the channels of the terminal to the wireless channel on which the access point performs processes without remaining in the wireless channel which performs inter-terminal direct communication.

Note that one channel change notification method is a method which uses DLS as shown in FIG. 17. Other than methods which use the Association procedure shown in FIG. 21, there is a method of using a unique frame not defined in the IEEE802.11.

In order to use the unique frame, the terminal and the access point must interpret a unique frame; by using the unique frame, processes can be streamlined.

Below, the process for the channel change notification using a unique frame is explained. As an example, a case in which inter-terminal direct communication is performed from terminal 102 to terminal 103 is explained.

First, when terminal 102 performs inter-terminal direct communication, according to conditions, terminal 102 does not issue a request for inter-terminal direct communication via the access point 101, and instead switches channels to directly issue a request to terminal 103.

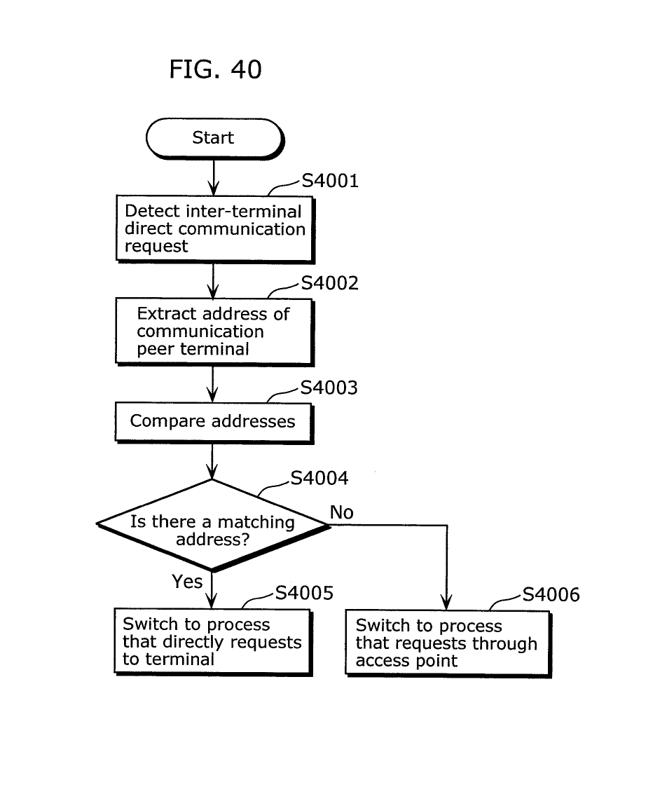

FIG. 40 is a flowchart which shows a flow of processes in terminal 102 for determining a method of issuing a request for inter-terminal direct communication.

For example, terminal 102 includes a memory region. Address information for a terminal which can perform inter-terminal direct communication is held beforehand in the memory region of terminal 102. Note that the address information for the terminal which can perform inter-terminal direct communication may be an address designated by the user.

Terminal 102 detects the request for inter-terminal direct communication with terminal 103 (S4001). For example, terminal 102 detects the request for inter-terminal direct communication via a command and so on. Next, terminal 102 extracts the address from the peer destination terminal 103, the address being requested by a command, a setting or a request packet (S4002). Terminal 102 compares the extracted address, and the address information of the terminal that is capable of inter-terminal direct communication, which is held in the memory region (S4003). As a result of the comparison, when the extracted address of terminal 103 is included in the held address information (Yes in S4003), terminal 102 switches to a process for directly performing a request for inter-terminal direct communication (S4005). When the extracted address of terminal 103 is not included in the held address information (No in S4003), terminal 102 switches to the process for performing a request for inter-terminal direct communication with terminal 103 via the access point 101 (S4006).

Below, a process is explained by which terminal 102 issues a request for direct inter-terminal direct communication and a channel change notification to terminal 103.

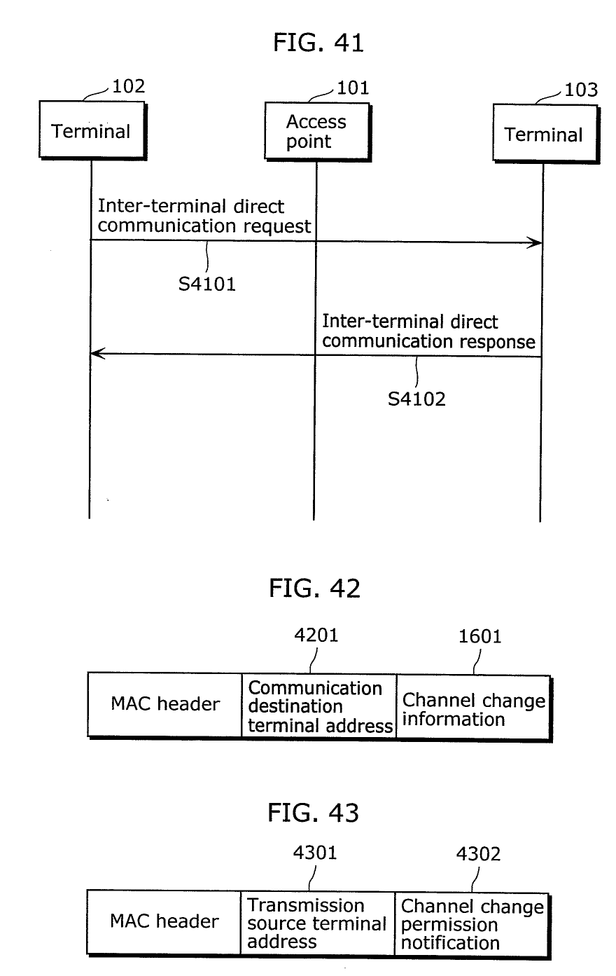

FIG. 41 is a diagram which shows a flow of processes for issuing a channel change notification using the unique frame.

Note that terminal 102 and terminal 103 can interpret the uniquely defined frame according to inter-terminal direct communication. Also, the access point 101 supports inter-terminal direct communication and can interpret the uniquely defined frame.

Terminal 102 transmits the uniquely defined inter-terminal direct communication request frame to terminal 103 (S4101). The inter-terminal direct communication request frame is a signal which requests that the terminal which is a communication peer 103 perform inter-terminal direct communication. Terminal 103 transmits an inter-terminal direct communication response frame, which is uniquely defined, as the response (S4102). The inter-terminal direct communication response frame is a signal which indicates whether or not terminal 103 can perform inter-terminal direct communication.

Terminal 102 performs inter-terminal direct communication with terminal 103 when the request to perform inter-terminal direct communication is permitted by the inter-terminal direct communication response frame transmitted by terminal 103.

FIG. 42 is a diagram which shows the structure of an inter-terminal direct communication request frame transmitted in Step S4101. The inter-terminal direct communication request frame shown in FIG. 42 includes a MAC header, a communication destination terminal address 4201 and channel change information 1601. The communication destination terminal address 4201 indicates the address of terminal 103 which is the communication destination terminal. The channel change information 1601 is information which expresses changing channels in order to perform inter-terminal direct communication and for example is the same as the channel change information 1601 shown in FIG. 22.

FIG. 43 is a diagram which shows the structure of an inter-terminal direct communication response frame transmitted in Step S4102. The inter-terminal direct communication response frame shown in FIG. 43 includes a MAC header, a transmission source terminal address 4301, and a channel change permission notification 4302. The transmission source terminal address 4301 shows the address of terminal 103 which is the transmission source terminal of the inter-terminal direct communication. In other words, an address that is the same as the communication destination terminal address 4201 for the inter-terminal direct communication request frame is set in the terminal address 4301. The channel change permission notification 4302 is a field which shows whether or not terminal 103 permits inter-terminal direct communication with terminal 102. Terminal 102, which receives the inter-terminal direct communication response frame, can judge whether or not terminal 103 can perform inter-terminal direct communication by confirming the channel change permission notification 4302.

It follows from the above that the terminal 102 can perform inter-terminal direct communication using a wireless channel that differs from the wireless channel used by the access point 101 in wireless communication, since terminal 102 requests inter-terminal direct communication to terminal 103 and bypasses the access point 101. Thus, compared to when terminal 102 requests inter-terminal direct communication via the access point 101, the process for starting inter-terminal direct communication can be streamlined.

Also, by utilizing a multi-caster address or a broadcast address in the address of the inter-terminal direct communication request frame and the inter-terminal direct communication response frame, the access point 101 which is the base station can receive the inter-terminal direct communication request frame and the inter-terminal direct communication response frame. Thus, terminal 102, terminal 103 and the base station side can ascertain the conditions of inter-terminal direct communication by exchanging a frame once between terminal 102 and terminal 103. Thus, the processes of terminal 102, 103 and the access point 101 can be. streamlined.

Ideally, terminal 102 performs the necessary processes for inter-terminal direct communication shown in FIG. 40 and FIG. 41, after terminal 102, which performs inter-terminal direct communication, has performed a process for detecting inter-terminal direct communication, in order to confirm whether or not a terminal that can perform inter-terminal direct communication beforehand within the same base station is present.

Below, the operations for detecting inter-terminal direct communication are explained.

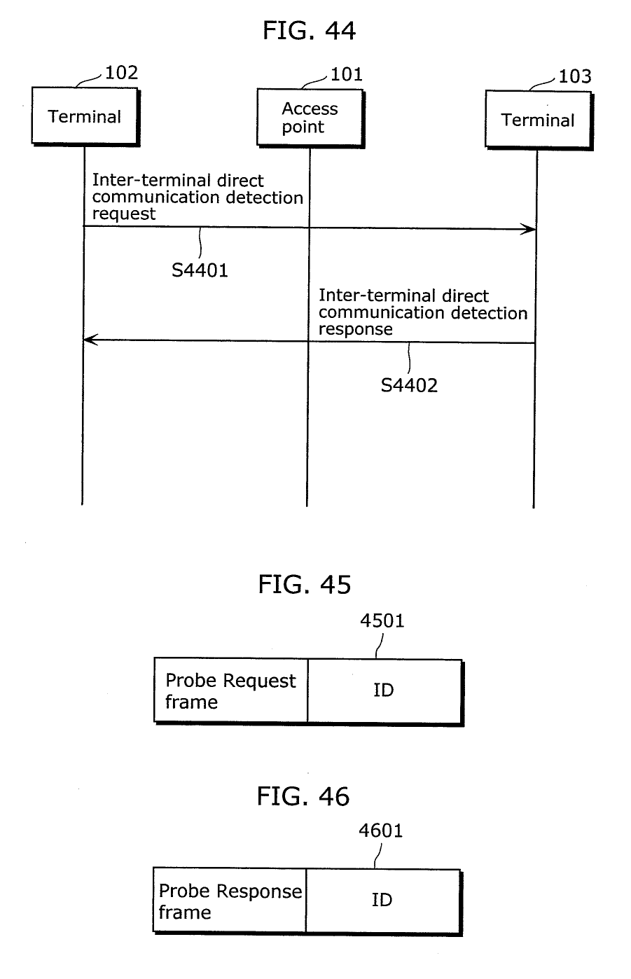

FIG. 44 is a diagram which shows a process flow for inter-terminal direct communication by terminal 102.

Terminal 102 transmits the inter-terminal direct communication detection request frame to terminal 103 (S4401). The inter-terminal direct communication detection request frame is a signal for detecting a terminal which can perform inter-terminal direct communication. For example, a pre-existing ProbeRequest frame may be used in the inter-terminal direct communication detection request frame.

FIG. 45 is a diagram which shows the structure of an inter-terminal direct communication detection request frame which uses the ProbeRequest frame. The inter-terminal direct communication detection request frame shown in FIG. 45 includes the ID field 4501. The ID field 4501 is an ID which displays the inter-terminal direct communication detection request. Terminal 103, which has received the inter-terminal direct communication detection request frame, ascertains that the inter-terminal direct communication detection response has been requested by confirming the ID field 4501.

Terminal 103, which has received the inter-terminal direct communication detection request frame, transmits the inter-terminal direct communication detection response frame to terminal 102 (S4402). The inter-terminal direct communication detection response frame is a signal which indicates whether or not the terminal which receives the inter-terminal direct communication detection request frame can perform inter-terminal direct communication. For example, the pre-existing ProbeResponse frame may be used in the inter-terminal direct communication detection response frame.

FIG. 46 is a diagram which shows the structure of the inter-terminal direct communication detection response frame which uses the ProbeResponse frame. The inter-terminal direct communication detection response frame shown in FIG. 46 includes the ID field 4601. The ID field 4601 is an ID which displays the inter-terminal direct communication detection response.

Terminal 102, which receives the inter-terminal direct communication response frame, can judge whether or not terminal 103 can perform inter-terminal direct communication by confirming the ID field 4601. Terminal 102 transmits the inter-terminal direct communication request frame to terminal 103 when terminal 102 judges that terminal 103 is capable of performing inter-terminal direct communication. Terminal 102 does not transmit the inter-terminal direct communication request frame to terminal 103 when terminal 102 judges that terminal 103 is incapable of performing inter-terminal direct communication. In this way, terminal 102 can ascertain whether a terminal, which is a communication peer, is compatible with inter-terminal direct communication before transmitting the inter-terminal direct communication request frame to the terminal, which is a communication peer.

Note that in the explanation above, a case in which terminal 102 requests inter-terminal direct communication to terminal 103 and bypasses the access point 101 is exemplified, however a case in which terminal 102 requests inter-terminal direct communication to terminal 102 via the access point 101 may also be performed.

It follows from the above that terminal 102 transmits the request for inter-terminal direct communication after judging whether or not the terminal, which is a communication peer 103, can perform inter-terminal direct communication. Thus, when terminal 103 cannot perform inter-terminal direct communication, the processing load can be reduced since terminal 103 does not transmit the inter-terminal direct communication request frame.

Also, besides the method of issuing a notification that the transmission frame has finished using the de-authentication frame shown in FIG. 38 and FIG. 39, there is a method for issuing a notification that inter-terminal direct communication has finished, which uses the undefined unique frame in IEEE802.11.

As described above, when the terminal which performs inter-terminal direct communication has finished inter-terminal direct communication due to the notification that the transmission frame in the de-authentication frame has finished, the terminal is disconnected from the base station. When communication is re-opened with the base station, the terminal must perform a connection procedure with the base station again. By using an inter-terminal direct communication cancellation request frame as mentioned below, the terminal does not disconnect from the base station and inter-terminal direct communication can be finished.

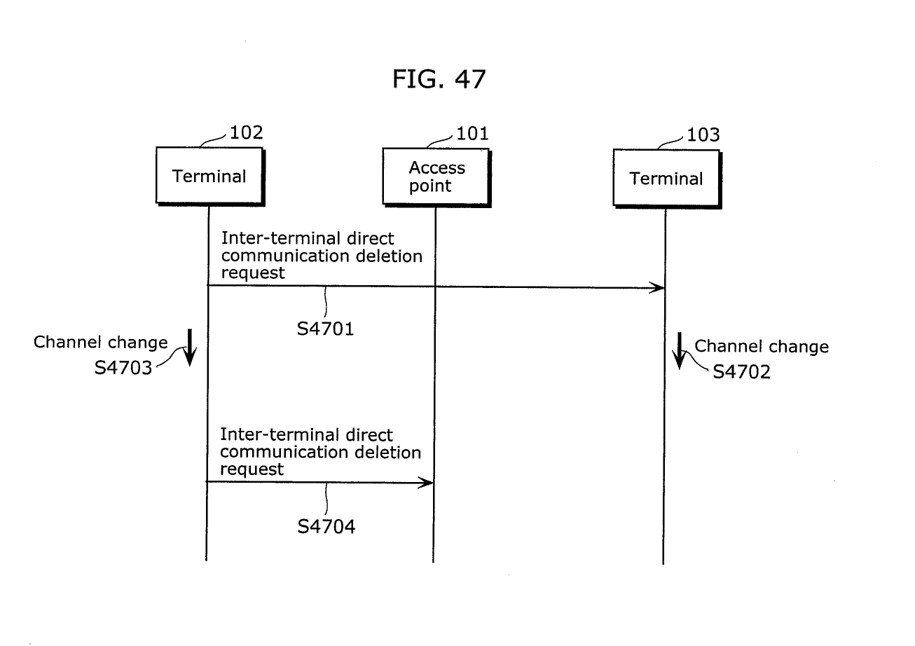

FIG. 47 is a diagram which shows a process in which the terminal which performs inter-terminal direct communication stops communication using the inter-terminal direct communication cancellation request frame.

Terminal 102 transmits the inter-terminal direct communication cancellation request frame to terminal 103, which is a communication peer, when terminal 102 finishes inter-terminal direct communication (S4701). The inter-terminal direct communication cancellation request frame is a signal which notifies terminal 103 to switch the wireless channel used in wireless communication from the wireless channel used in inter-terminal direct communication to the wireless channel used by the access point 101.

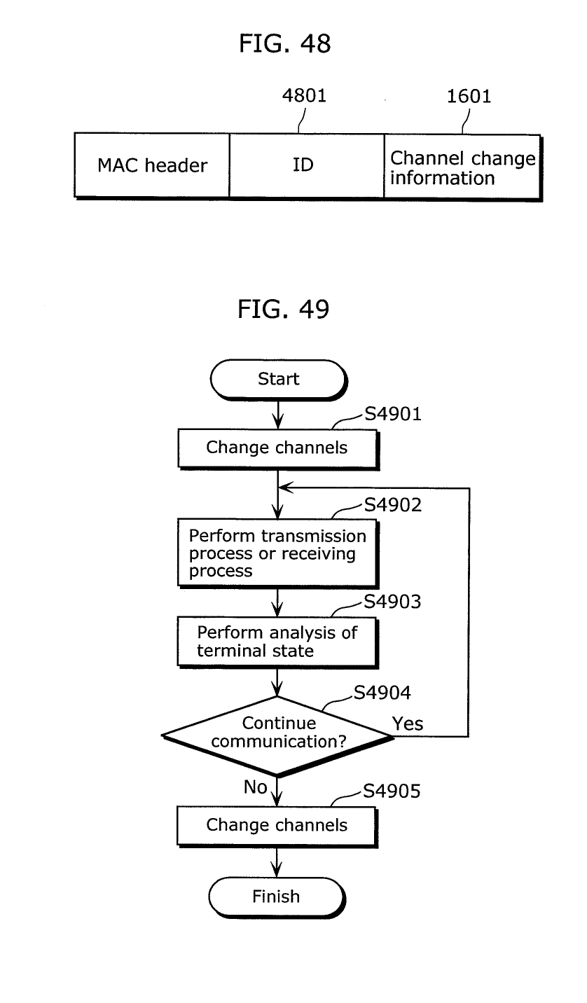

FIG. 48 is a diagram which shows the structure of the inter-terminal direct communication cancellation request frame. The inter-terminal direct communication cancellation request frame shown in FIG. 48 includes the MAC header, an ID field 4801 and the channel change information 1601. The ID field 4801 is an ID which shows the inter-terminal direct communication cancellation request. The channel change information 1601 is information about terminal 102 changing channels. The channel change information 1601 is, for example, the same as the channel change information 1601 shown in FIG. 22.

Terminal 103, which has received the inter-terminal direct communication cancellation request frame, finishes inter-terminal direct communication and prepares to change channels. At this point terminal 103 may obtain information necessary for changing channels by analyzing the channel change information 1601 in FIG. 48. Also, terminal 103 performs frame identification by confirming the ID field 4801. Terminal 103 changes channels with a pre-determined timing mentioned above which is recorded in the channel change information 1601 (S4702). Also, terminal 102 changes channels with the predetermined timing described in the channel change information 1601 (S4703). In other words, terminal 102 switches the wireless channel used in wireless communication from the wireless channel used in inter-terminal direct communication to the wireless channel used by the access point 101 after transmitting the inter-terminal direct communication cancellation request frame. In this way, terminal 102 and terminal 103 change channels to the same channel as the access point 101, which is the base station.

Terminal 102, which has changed to the same channel as the access point 101, transmits the inter-terminal direct communication cancellation request frame to the access point 101 in order to issue a notification that inter-terminal direct communication has finished (S4704). The access point 101 which has received the inter-terminal direct communication cancellation request frame releases each type of resource secured for inter-terminal direct communication. Also, in the case where the access point 101 changes channels for the terminal which performs inter-terminal direct communication, the access point 101 stops the channel change.

It follows from the above that terminal 102 transmits the inter-terminal direct communication cancellation request frame to terminal 103 when finishing inter-terminal direct communication. By doing so, terminal 102 and terminal 103 can change channels to a wireless channel used by the access point 101 after finishing inter-terminal direct communication. In other words, terminal 102 and terminal 103 can finish inter-terminal direct communication without being disconnected from the access point 101.

Also, in the case where terminal 103 which performs inter-terminal direct communication cannot communicate with terminal 102 due to an unforeseen state (the power drops, communication conditions deteriorates and so on), wasteful consumption of power may occur by continuing communication with terminal 103, which cannot communicate. Thus, wasteful consumption of power can be decreased by judging the present communication status and whether inter-terminal direct communication should be continued.

Below, the process of judging the communication status in inter-terminal direct communication by terminal 102 is explained.

FIG. 49 is a flowchart which shows a flow of the process for judging the communication status of terminal 102. Note that terminal 102 performs inter-terminal direct communication with terminal 103.

In order for terminal 102 shown in FIG. 49 to perform inter-terminal direct communication with terminal 103, the wireless channel used by the access point 101 in communication is changed to a different wireless channel (S4901). Next, terminal 102 transmits data to terminal 103 or receives data from terminal 103 using inter-terminal direct communication (S4902). Next, terminal 102 analyzes the communication status in inter-terminal direct communication with terminal 103 (S4903). Next, terminal 102 judges whether or not communication should be continued based on the analysis result of the communication status (S4904).

When the communication is judged to have finished (No in S4904), terminal 102 finishes inter-terminal direct communication with terminal 103 and changes channels to the wireless channel used by the access point 101 in communication (S4905). On the other hand, when it is judged that communication should be continued (Yes in S4904), terminal 102 continues to transmit data to terminal 103 or receive data from terminal 103 using inter-terminal direct communication (S4902).

It follows from the above that when terminal 102 judges that communication should not be continued, terminal 102 can communicate with the access point 101 after changing channels. Also, wasteful power consumption, which occurs when communication is continued with a terminal that cannot communicate, can be reduced.

Also, the following process may be performed instead of the process shown in FIG. 49.

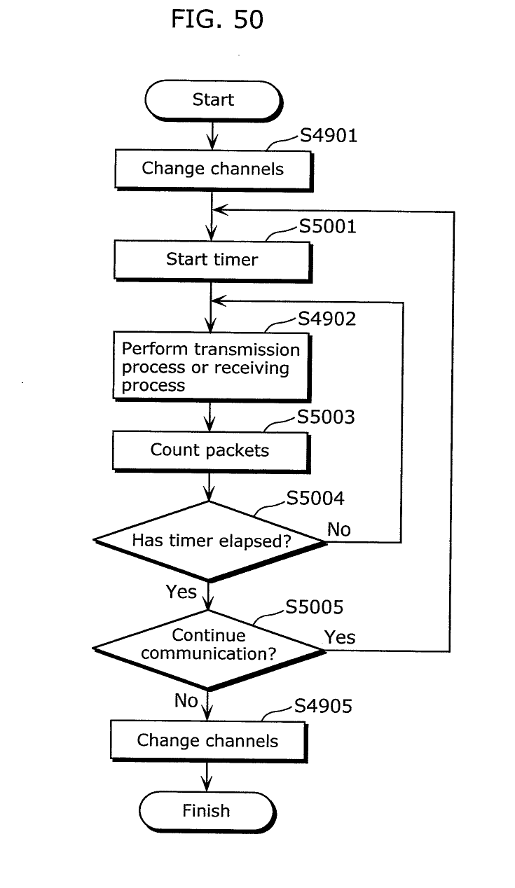

FIG. 50 is a flowchart which shows a modification of the process flow for judging the communication status of terminal 102.

Note that terminal 102 performs inter-terminal direct communication with terminal 103.

In order for terminal 102 shown in FIG. 50 to perform inter-terminal direct communication with terminal 103, the terminal 102 changes channels to a wireless channel different from the wireless channel used by the access point 101 for communication (S4901). Next, terminal 102 starts the timer (S5001). The timer counts a predetermined time period while terminal 102 and terminal 103 perform inter-terminal direct communication. Next, terminal 102 transmits data to terminal 103 or receives data from terminal 103 using inter-terminal direct communication (S4902). Next, terminal 102 counts the number of packets transmitted or received by inter-terminal direct transmission with terminal 103 while the predetermined time period is being counted by the timer (S5003).

In other words, terminal 102 counts the number of packets which were successfully transmitted or received in Step S4902.

When the timer count has not reached the predetermined time period (No in S5004), terminal 102 continues to transmit data to terminal 103 or to receive data from terminal 103 (S4902) and count the packets (S5003) using inter-terminal direct communication. In other words, terminal 102 performs inter-terminal direct communication with terminal 103 while the predetermined time period is counted by the timer. Terminal 102 counts the number of packets transmitted or received using inter-terminal direct transmission with terminal 103 while the predetermined time period is counted by the timer.

When the predetermined time period has passed and the timer has expired (Yes in S5004), terminal 102 judges whether or not to continue communication (S5005). More specifically, terminal 102 judges that communication should be continued when the total amount of packets counted in Step S5003 within the period until the timer has expired is greater than a predetermined threshold value, and judges that communication should finish when the total amount of packets is smaller than the predetermined threshold value.

When the communication is judged to have finished (No in S5005), terminal 102 finishes inter-terminal direct communication with terminal 103 and changes channels to the wireless channel used by the access point 101 in communication (S4905). On the other hand, when it is judged that communication should be continued (Yes in S5005), terminal 102 continues communication and transmits data to terminal 103 or receives data from terminal 103 using inter-terminal direct communication (S4902).

It follows from the above that terminal 102 can efficiently make a judgment by comparing judgment of whether inter-terminal direct communication should be continued at every predetermined period, and judgment of whether inter-terminal direct communication should be continued at every transmission or reception.

Note that the set value of the timer, which is the time period in which packets are counted, may use a fixed value set in terminal 102, or the user may set an arbitrary value according to conditions. In the same way, the arbitrary value used in Step S5004 may use a fixed value set in terminal 102 or the user may set an arbitrary value according to conditions.

Also, when it has been judged that inter-terminal direct communication should not be continued by judging the communication status, it is conceivable that the reason that inter-terminal direct communication should not be continued is that the terminal, which is a communication peer, cannot perform data communication for some reason. In this case, although the buffer which transmits or receives data may be depleted and data cannot be transmitted or received, a control frame and so on can be accepted. Thus, after the communication is judged to be finished, the communication status can be more reliably judged by judging whether or not the control frame and so on can be accepted.

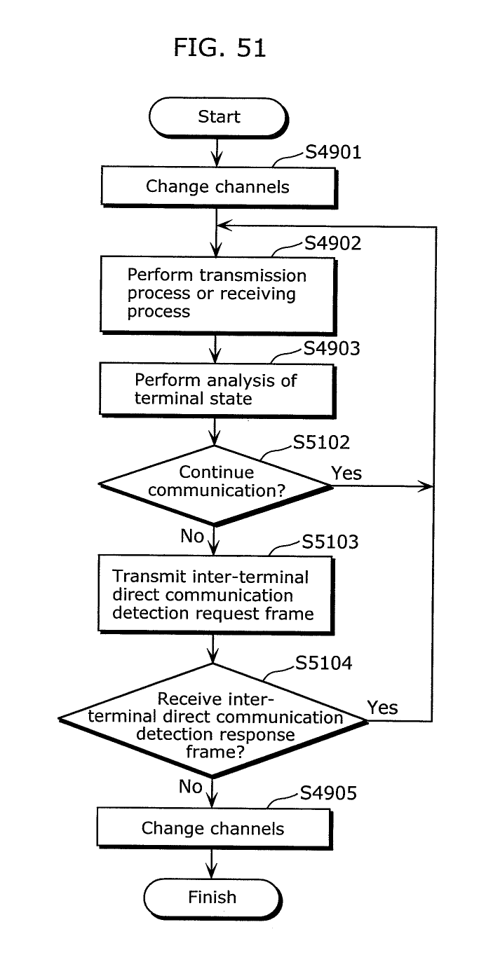

FIG. 51 is a flowchart which shows a modification of the process flow for judging the communication status of terminal 102. Note that terminal 102 performs inter-terminal direct communication with terminal 103.

The processes up until the analysis of the terminal status (S4901 through S4903) are the same as in FIG. 49 and the explanation is not repeated. Terminal 102 shown in FIG. 51 judges whether or not inter-terminal direct communication should be continued with terminal 103 based on the result of the analysis of the communication state (S5102).

When it is judged that communication should be finished (No in S5102), terminal 102 transmits the inter-terminal direct communication detection request frame to terminal 103 (S5103). The inter-terminal direct communication detection request frame is a signal for detecting a terminal which can perform inter-terminal direct communication. Terminal 102 judges whether or not terminal 103 can perform inter-terminal direct communication based on the response to the inter-terminal direct communication detection request frame from terminal 103 (S5104). More specifically, when terminal 103 can accept a control frame and the like, terminal 103 responds with an inter-terminal direct communication detection response frame to the inter-terminal direct communication detection request frame from terminal 102. Also, when-terminal 103 cannot accept a control frame and the like, terminal 103 does not respond with an inter-terminal direct communication detection response frame to the inter-terminal direct communication detection request frame from terminal 102. Thus, when terminal 102 receives the inter-terminal direct communication detection response frame transmitted by terminal 103, terminal 102 judges that terminal 103 can accept the control frame and the like. Also, when terminal 102 does not receive the inter-terminal direct communication detection response frame from terminal 103, terminal 102 judges that terminal 103 cannot accept the control frame and the like.

When there is not a response from terminal 103 in Step S5104 (No in S5104), terminal 102 finishes inter-terminal direct communication with terminal 103 and changes channels to the wireless channel used by the access point 101 (S4905). On the other hand, when there is a response from terminal 103 (Yes in S5104), terminal 102 re-transmits or re-receives data using inter-terminal direct communication (S4902). In other words, terminal 102 continues to perform inter-terminal direct communication with terminal 103.

It follows from the above that when terminal 102 is judged to have finished communication in Step S5102, it is judged whether or not the control frame and the like can be accepted by confirming the response of terminal 103 to the inter-terminal direct communication detection request frame. Thus, when the terminal which is a communication peer temporarily cannot communicate data for some reason, inter-terminal direct communication can be continued. In other words, the communication status can be judged more reliably.

Also, wireless status may temporarily deteriorate, making data transmission and reception for terminal 103 difficult, which can prevent the peer-side terminal 103, which performs inter-terminal direct communication, from being able to communicate data. In this case, in addition to the process in FIG. 51, when the Acknowledgement frame is judged to have been received from terminal 103, the judgment of whether communication should be continued can be made more reliable, even when wireless conditions are poor.

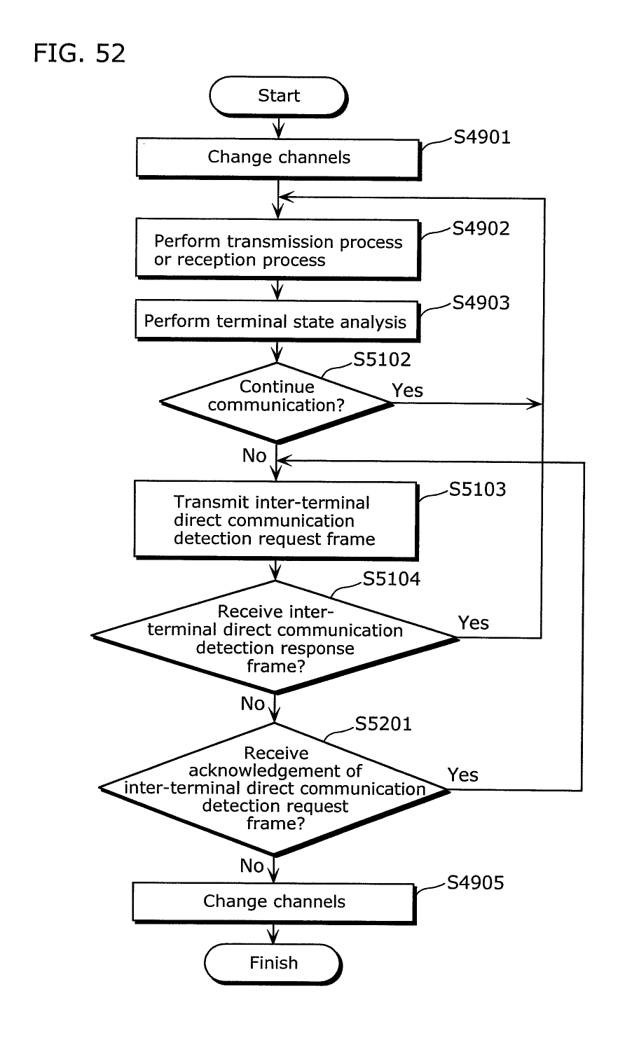

FIG. 52 is a flowchart which shows a modification of the process flow for judging the communication status of terminal 102. Note that terminal 102 performs inter-terminal direct communication with terminal 103. Also, besides the process in Step S5201 shown in FIG. 52, the processes are the same as the processes shown in FIG. 51 and the explanation is not repeated.

As shown in FIG. 52, when there is no response from terminal 103 in Step S5104 (No in S5104), terminal 102 judges whether or not an Acknowledgement frame for the inter-terminal direct communication detection request frame transmitted in Step S5103 has been received from terminal 103 (S5201). Here, the Acknowledgement frame has a shorter frame length than other frames and is transmitted at a slower transfer rate than the normal data transfer. In other words, there is a high possibility that the Acknowledgement frame can be received even when the wireless conditions are comparatively poor.

In the case where terminal 102 has received the acknowledgement frame (Yes in S5201), terminal 102 judges that the cellular status is temporarily poor and re-transmits the inter-terminal direct communication detection request frame to terminal 103 (S5103).

On the other hand, when terminal 102 has not received the Acknowledgement frame (No in S5201), terminal 102 finishes inter-terminal direct communication with terminal 103 and changes channels to the wireless channel utilized by the access point 101 in communication (S4905).

It follows from the above that terminal 102 judges whether or not the wireless status is temporarily deteriorated by judging whether or not the Acknowledgement frame has been received from terminal 103. When the wireless status is temporarily poor, terminal 102 re-transmits the inter-terminal direct communication detection request frame. In so doing, communication can be continued when the wireless conditions improve. In other words, it can be judged more reliably whether communication must be continued.

Also, when the cellular status temporarily deteriorates as described above, terminal 102 can improve efficiency by transmitting the inter-terminal direct communication detection request frame to terminal 103 after a fixed time period.

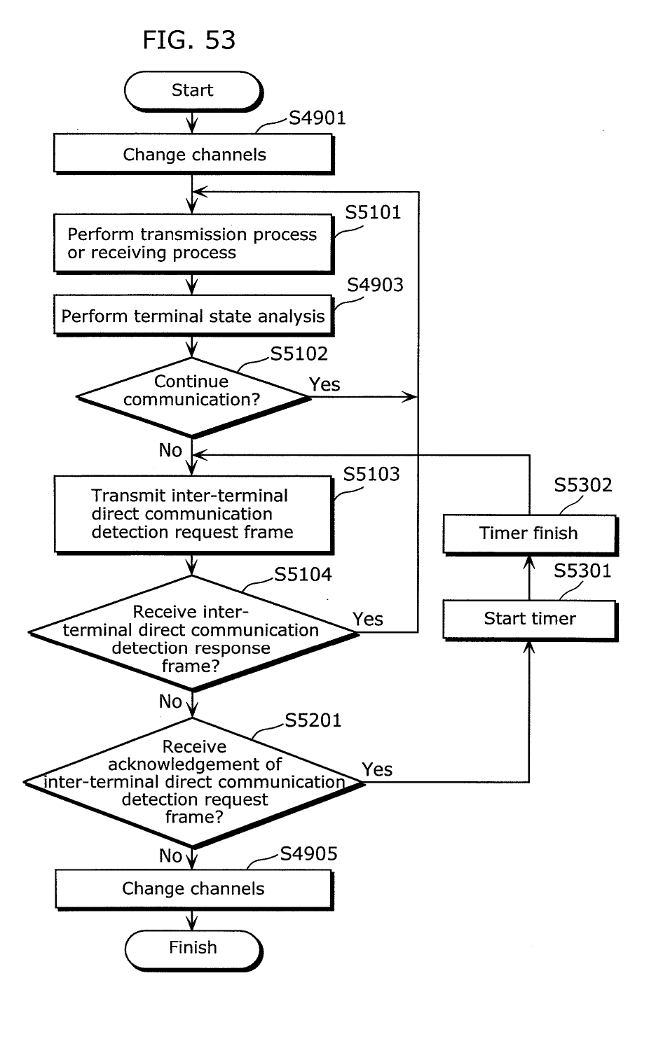

FIG. 53 is a flowchart which shows a modification of the process flow for judging the communication status of terminal 102. Note that terminal 102 performs inter-terminal direct communication with terminal 103. Also, besides processes in Step S5301 and S5302 shown in FIG. 53, the processes are the same as the processes shown in FIG. 52 and the explanations are not repeated.

As shown in FIG. 53, when terminal 102 has received the Acknowledgement frame (Yes in S5201), the timer starts (S5301). When the predetermined time period is counted and the timer expires (S5302), terminal 102 re-transmits the inter-terminal direct communication detection request frame to terminal 103 (S5103).

It follows from the above that when the cellular conditions temporarily deteriorate, terminal 102 transmits the inter-terminal direct communication detection request frame to terminal 103 after a fixed time period. Thus, terminal 102 can improve efficiency since wasteful transmission of the inter-terminal direct communication detection request frame can be reduced.

Note that in FIG. 51, FIG. 52 and FIG. 53, examples of new processes added to the processes shown in FIG. 49 are shown, however the same processes may be added to the processes shown in FIG. 50.

Also, in the explanations above, inter-terminal direct communication performed between the two terminals, terminal 102 and terminal 103, is explained, however inter-terminal direct communication may be performed by at least two terminals. For example, three terminals, terminal 102, terminal 103 and terminal 104 may perform inter-terminal direct communication using different wireless channels from the wireless channel used by the access point 101. Also, when wireless links are established between the access point 101 and at least four terminals, different channels are respectively used and plural inter-terminal direct communications may be performed in parallel. For example, when two inter-terminal direct communications are performed in parallel, the access point may use channel 1 and the two inter-terminal direct communications may use channel 3 and channel 5 respectively.

As above, in the wireless communication system according to the present embodiment, the terminal uses a wireless channel different from the wireless channel used in wireless communication with the base station, and performs inter-terminal direct communication, which is communication that bypasses the base station, with another terminal. Thus, even when inter-terminal direct communication and communication between the base station and another terminal are performed simultaneously, data transmission in inter-terminal direct communication and data transmission between the base station and the other terminal can be performed in parallel since the wireless channels used differ. In other words, even when inter-terminal direct communication and communication between the base station and the other terminal are performed simultaneously, the throughput does not drop. Thus, the wireless communication system according to the present embodiment can realize a high throughput even when communications are performed between plural terminal pairs.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to a wireless communication system and a wireless terminal, and can be applied in particular to a wireless LAN system which includes a PC or AV equipment equipped with a wireless LAN function and so on (for example, an AV server which includes an access point function, a TV which includes a wireless terminal function, a DVD player which includes a wireless terminal function, a DVD recorder which includes a wireless communication function, and so on). Also, the present invention can be applied to a wireless communication system which includes communication equipment such as an IP phone.

What is claimed is:

1. A wireless communication system comprising:
a wireless LAN base station; and
plural terminals which mutually communicate through said wireless LAN base station,
wherein each of said terminals includes a communication unit operable to perform inter-terminal direct communication with an other terminal, using a second wireless channel that is different from a first wireless channel, the first wireless channel being used in wireless communication with the base station, inter-terminal direct communication being communication that bypasses said wireless LAN base station.

2. The wireless communication system according to claim 1,
wherein each communication unit includes a request transmission unit operable to transmit a request signal which is a signal that requests said wireless LAN base station to perform inter-terminal direct communication;
said wireless LAN base station includes a permission unit operable to permit said terminal which transmits the request signal and a terminal which is a communication peer for said terminal which transmits the request signal to perform inter-terminal direct communication; and
said communication unit is operable to perform inter-terminal direct communication with the terminal which is a communication peer when permitted by said permission unit.

3. The wireless communication system according to claim 2,
wherein said request transmission unit is operable to request to said wireless LAN base station that inter-terminal direct communication be performed using an information element of a Direct Link Setup request.

4. The wireless communication system according to claim 2,
wherein said request transmission unit is operable to request said wireless LAN base station to perform inter-terminal direct transmission using an information element of an association-request.

5. The communication system according to claim 1,
wherein said wireless LAN base station includes:
a notification signal generation unit operable to generate a notification signal which includes first channel information which is information about a wireless channel that is compatible with each of the plural terminals; and
a notification signal transmission unit operable to periodically transmit the notification signal generated by said notification signal generation unit,
said communication unit includes a notification signal reception unit operable to receive the notification signal, and
each of said terminals includes a channel selection unit operable to select the second wireless channel from among wireless channels compatible with the terminal which is a communication peer which are included in the notification signal received by said notification signal reception unit.

6. The wireless communication system according to claim 5,
wherein each of said terminals includes a channel information holding unit operable to hold second channel information which is information about a wireless channel with which said terminal itself is compatible,
said communication unit includes a channel information transmission unit operable to transmit the second channel information held by said channel information holding unit to said wireless LAN base station, and
said notification signal generation unit is operable to generate the first channel information based on the second channel information transmitted from said channel information transmission unit in each of said terminals.

7. The wireless communication system according to claim 1,
wherein each of said terminals includes a first channel information holding unit operable to hold channel information which is information about a wireless channel with which said terminal is compatible,
said communication unit includes a channel information transmission unit operable to transmit the channel information held by said first channel information holding unit to said wireless LAN base station, and
the base station includes:
a second channel information holding unit operable to hold the channel information transmitted by said channel information transmission unit of each of said terminals;
a judgment unit operable to judge a wireless channel compatible with each of the plural terminals which perform inter-terminal direct communication, using the channel information in each of said terminals held by said second channel information holding unit; and
a channel selection unit operable to select the second wireless channel from among the wireless channels judged to be compatible by said judgment unit.

8. The wireless communication system according to claim 7,
wherein said wireless LAN base station includes:
a notification signal generation unit operable to generate a notification signal which includes information about the second wireless channel selected by said channel selection unit; and
a notification signal transmission unit operable to transmit the notification signal generated by said notification signal generation unit to said terminal.

9. The wireless communication system according to claim 7,
wherein said channel selection unit is operable to select a wireless channel distanced at least two channels from the first wireless channel.

10. The wireless communication system according to claim 7,
wherein said channel selection unit includes a use judgment unit operable to judge whether or not a wireless channel is in use based on whether or not the notification signal is received in each wireless channel available for wireless communication, and
said channel selection unit is operable to select the wireless channel used in inter-terminal direct communication from the wireless channels judged by said use judgment unit to be available.

11. The wireless communication system according to claim 7,
wherein said channel selection unit includes a measurement unit operable to measure a traffic density of each wireless channel available for wireless communication, and
said channel selection unit is operable to select the wireless channel to be used from among the wireless channels with traffic density less than a predetermined value based on the measurement result by said measurement unit.

12. The wireless communication system according to claim 1,
wherein said wireless LAN base station includes a notification signal transmission unit operable to periodically transmit a notification signal, and
each of the plural terminals includes:
a notification signal reception unit operable to receive the notification signal;
a counting unit operable to count an amount of notification signals received by said notification reception unit; and
a channel switching unit operable to switch the wireless channel to be used in wireless communication from the first wireless channel to the second wireless channel in the case where a count value of said counting unit reaches a predetermined amount.

13. The wireless communication system according to claim 1,
wherein said communication unit includes:
a synchronization signal transmission unit operable to transmit a synchronization signal to said terminal, which is a communication peer, using the first wireless channel;
a synchronization signal response unit operable to respond to the terminal which is a communication peer using the first wireless channel, with information that indicates whether or not said terminal itself is in a state in which channel switching can be performed, when the synchronization signal is received from the terminal which is a communication peer;
a channel switching unit operable to switch the wireless channel used in wireless communication from the first wireless channel to the second wireless channel, in the case where said synchronization signal response unit has responded to the synchronization signal transmitted from said synchronization signal transmission unit in the terminal which is a communication peer, that the channels can be switched, and
said channel switching unit is further operable to switch the wireless channel used in wireless communication from the first wireless channel to the second wireless channel, in the case where said synchronization signal transmission unit transmits the synchronization signal to the terminal which is a communication peer and there is a response from the terminal which is a communication peer which indicates that the terminal which is a communication peer is in a state where the channels can be switched.

14. The wireless communication system according to claim 1,
wherein said wireless LAN base station includes
a transmission prohibited signal generation unit operable to generate a transmission prohibited signal which is a signal to which information has been added and which indicates that data from said terminal which performs wireless communication on the first wireless channel is prohibited from being transmitted;
a transmission prohibition signal transmission unit operable to transmit the transmission prohibited signal on the first wireless channel to said terminal which performs wireless communication on the first wireless channel; and
a channel switching unit operable to switch the wireless channel used in wireless communication from the first wireless channel to the second wireless channel after said transmission prohibited signal transmission unit transmits the transmission prohibited signal to said terminal which performs wireless communication on the first wireless channel.

15. The wireless communication system according to claim 14,
wherein said wireless LAN base station includes
a QoS-CF-Poll signal transmission unit operable to transmit a QoS-CF-Poll signal using the second wireless channel switched to by said channel switching unit, the QoS-CF-Poll signal being a signal that permits inter-terminal direct communication to start.

16. The wireless communication system according to claim 1,
wherein the base station includes
a channel switching unit operable to switch the wireless channel used in wireless communication periodically from the first wireless channel to the second wireless channel; and
a notification signal transmission unit operable to transmit a notification signal periodically to the second wireless channel.

17. The wireless communication system according to claim 1,
wherein the base station includes
a notification signal transmission unit operable to periodically transmit a notification signal to the first wireless channel;
the communication unit includes
a channel switching unit operable to switch the wireless channel used in wireless communication periodically from the second wireless channel to the first wireless channel; and
a notification signal reception unit operable to receive the notification signal transmitted on the first wireless channel.

18. The wireless communication system according to claim 17,
wherein said wireless LAN base station includes
a data transmission unit operable to transmit data to one of said terminals using the first wireless channel,
said notification signal transmission unit is operable to transmit the notification signal including timing information, which is information about a timing for transmitting data using said data transmission unit,
said channel switching unit in said terminal which performs inter-terminal direct communication is operable to switch the wireless channel used in wireless communication from the second wireless channel to the first wireless channel on the timing based on the timing information included in the notification signal, and
said communication unit includes
a data reception unit operable to receive data from said wireless LAN base station on the first wireless channel.

19. The wireless communication system according to claim 1,
wherein said communication unit includes
a data transmission unit operable to transmit data to said wireless LAN base station; and
a channel switching unit operable to switch the wireless channel used in communication from the second wireless channel to the first wireless channel before said data transmission unit starts transmitting data.

20. The wireless communication system according to claim 19,
wherein said communication unit includes
an alert signal transmission unit operable to transmit an alert signal which is a signal for notifying said wireless LAN base station that communication is to be performed,
said alert signal transmission unit in said terminal which performs inter-terminal direct communication is operable to transmit the alert signal to said wireless LAN base station after the wireless channel used in communication is switched from the second wireless channel to the first wireless channel by said channel switching unit, and
said data transmission unit is operable to transmit the data after said notification signal transmission unit transmits the alert signal.

21. The wireless communication system according to claim 19,
wherein each of said terminals include a data judgment unit operable to judge whether or not there is data to be transmitted to said wireless LAN base station, and
said data transmission unit is operable to finish data transmission to said wireless LAN base station when said data judgment unit judges that there is no data to be transmitted to said wireless LAN base station during the data transmission to said wireless LAN base station.

22. The wireless communication system according to claim 19,
wherein each of said terminals includes a time judgment unit operable to judge whether or not a predetermined time elapses, and
said data transmission unit is operable to finish data transmission to said wireless LAN base station when said time judgment unit judges that the predetermined time period elapses during the data transmission to said wireless LAN base station.

23. The wireless communication system according to claim 19,
wherein each of said terminals include a transmission amount judgment unit operable to judge whether or not said communication unit performs a predetermined amount of data transmissions to said wireless LAN base station; and
said data transmission unit is operable to finish transmitting data to said wireless LAN base station when said transmission amount judgment unit judges that the predetermined amount of data transmissions are performed during the data transmission to said wireless LAN base station.

24. The wireless communication system according to claim 1,
wherein said communication unit includes:
a channel switching unit operable to switch the wireless channels used in communication; and
a finish notification unit operable to notify said wireless LAN base station to finish inter-terminal direct communication after said channel switching unit switches the channel used in wireless communication from the second wireless channel to the first wireless channel.

25. The wireless communication system according to claim 24,
wherein said finish notification unit is further operable to notify said terminal which is a communication peer, which performs inter-terminal direct communication to finish inter-terminal direct communication.

26. A wireless terminal which performs communication with another terminal through a wireless LAN base station, said wireless terminal comprising:
a communication unit operable to perform inter-terminal direct communication with another terminal, inter-terminal direct communication being communication that bypasses the wireless LAN base station and that uses a second wireless channel which differs from a first wireless channel, the first wireless channel being used in wireless communication with the wireless LAN base station.

27. The wireless terminal according to claim 26,
wherein said communication unit includes a request transmission unit operable to transmit a request signal, which is a signal that requests inter-terminal direct communication be performed, to the wireless LAN base station, and
said communication unit is operable to perform inter-terminal direct communication with the terminal which is a communication peer when a request in the request signal transmitted by said request transmission unit is permitted by the base station.

28. The wireless terminal according to claim 26,
wherein said communication unit includes
a notification signal reception unit operable to receive a notification signal which is periodically transmitted by the wireless LAN base station and includes first channel information which is information about wireless channels compatible with another terminal, and
the wireless terminal further includes
a channel selection unit operable to select the second wireless channel from among wireless channels compatible with the terminal which is a communication peer, which are included in the notification signal received by said notification signal reception unit.

29. The wireless terminal according to claim 28,
wherein said channel selection unit is operable to select a wireless channel distanced at least two channels from the first wireless channel as the second channel.

30. The wireless terminal according to claim 28,
wherein said channel selection unit includes a use judgment unit operable to judge whether or not the wireless channel is in use, based on whether or not the notification signal is received in each wireless channel available for wireless communication; and
said channel selection unit is operable to select the wireless channel used in inter-terminal direct communication from the wireless channels judged to be available by said use judgment unit.

31. The wireless terminal according to claim 28,
wherein said channel selection unit includes a measurement unit operable to measure the traffic density of each wireless channel available for wireless communication, and
said channel selection unit is operable to select the wireless channel to be used from among the wireless channels with the least amount of traffic density based on the measurement result by said measurement unit.

32. The wireless terminal according to claim 26, further comprising
a first channel information holding unit operable to hold channel information which is wireless channel information compatible with said terminal, and
said communication unit includes a channel information transmission unit operable to transmit the channel information held by said first channel information holding unit to the wireless LAN base station.

33. The wireless terminal according to claim 26,
wherein said communication unit includes:
a notification signal reception unit operable to receive a notification signal which is transmitted periodically on the first wireless channel by the wireless LAN base station, the notification signal including timing information which is information about the timing for transmitting data by the base station;
a channel switching unit operable to switch the wireless channel used in wireless communication from the second wireless channel to the first wireless channel on the timing based on the timing information included in the notification signal; and
a data reception unit operable to receive data from the wireless LAN base station on the first wireless channel.

34. The wireless terminal according to claim 26,
wherein said communication unit includes
a request transmission unit operable to transmit a request signal, which is a signal that requests inter-terminal direct communication be performed, to the terminal which is a communication peer;
said communication unit is operable to perform inter-terminal direct communication with the terminal which is a communication peer when a request in the request signal transmitted by said request transmission unit is permitted by the terminal which is a communication peer.

35. The wireless terminal according to claim 34,
wherein said communication unit further includes:
a detection signal transmission unit operable to transmit a detection signal for detecting a terminal which can perform inter-terminal direct communication; and
a terminal judgment unit operable to judge whether or not the terminal which is a communication peer can perform inter-terminal direct communication, based on a response from the terminal which is a communication peer to the detection signal transmitted by said detection signal transmission unit, and
said request transmission unit is operable to transmit the request signal to the terminal which is a communication peer when said terminal judgment unit judges that the terminal, which is a communication peer, can perform inter-terminal direct communication, and not to transmit the request signal to the terminal, which is a communication peer, when it is judged by said terminal judgment unit that the terminal, which is a communication peer, cannot perform inter-terminal direct communication.

36. The wireless terminal according to claim 26,
wherein said communication unit includes a finish notification unit operable to notify the terminal which is a communication peer to switch the wireless channel used in wireless communication from the second wireless channel to the first wireless channel when inter-terminal direct communication is finished, and
said communication unit is operable to switch the wireless channel used in wireless communication from the second wireless channel to the first wireless channel after the notification is issued by said finish notification unit.

37. The wireless terminal according to claim 26,
wherein said communication unit includes:
a communication state analysis unit operable to analyze a communication state of the inter-terminal direct communication with the terminal which is a communication peer; and
a communication continuation judgment unit operable to judge whether or not communication should be continued based on an analysis result of said communication state analysis unit.

38. The wireless terminal according to claim 37,
wherein said communication state analysis unit includes:
a timer unit operable to count a predetermined time period while inter-terminal direct communication is performed with the terminal which is a communication peer; and
a calculation unit operable to calculate a number of packets transmitted or received using inter-terminal direct communication with the terminal which is a communication peer, while the predetermined time is counted by said timer unit, and
said communication continuation judgment unit is operable to judge that communication should be continued when the amount of packets counted by said calculation unit is greater than a predetermined value and that communication should be ended when the number of packets counted by said counting unit is smaller than the predetermined value.

39. The wireless terminal according to claim 37,
wherein said communication unit further includes:
a detection signal transmission unit operable to transmit a detection signal for detecting a terminal which can perform inter-terminal direct communication to the terminal which is a communication peer when said communication continuation judgment unit judges that communication should be stopped; and
a terminal judgment unit operable to judge whether or not the terminal which is a communication peer can perform inter-terminal direct communication based on the response from the terminal which is a communication peer to the detection signal transmitted by said detection signal transmission unit, and
said communication unit is operable to finish the inter-terminal direct communication with the terminal which is a communication peer when said terminal judgment unit judges that the terminal which is a communication peer cannot perform inter-terminal direct communication.

40. The wireless terminal according to claim 39,
wherein said communication unit further includes
an acknowledgement judgment unit operable to judge whether or not an acknowledgement signal for the detection signal from the terminal which is a communication peer is received when said inter-terminal judgment unit judges that the terminal which is a communication peer cannot perform inter-terminal direct communication;
said detection signal transmission unit is operable to re-transmit the detection signal to the terminal which is a communication peer when said acknowledgement judgment unit judges that the acknowledgement signal is received, and
said communication unit is operable to finish inter-terminal direct communication with the terminal which is a communication peer when it is judged by said acknowledgement judgment unit that the acknowledgement signal is not received.

41. The wireless terminal according to claim 40,
wherein said communication unit further includes
a timer unit operable to count the predetermined time period, after said acknowledgement judgment unit judges that the acknowledgement signal is received; and
said detection signal transmission unit is operable to re-transmit the detection signal to the terminal which is a communication peer after the predetermined time period is counted by said timer unit.

42. A wireless communication method for a wireless communication system which includes a wireless LAN base station; and plural terminals which mutually communicate through said wireless LAN base station,
wherein each of said terminals perform inter-terminal direct communication with an other terminal, using a second wireless channel that is different from a first wireless channel, the first wireless channel being used in wireless communication with the base station, inter-terminal direct communication being communication that bypasses said wireless LAN base station.
